(19) United States
(12) Patent Application Publication
(10) Pub. No.: US 2004/0098154 A1
(43) Pub. Date: May 20, 2004

(54) Method and apparatus for computer system engineering

(76) Inventor: Brendan McCarthy, Piano, TX (US)

Correspondence Address: HOGAN & HARTSON LLP, ONE TABOR CENTER, SUITE 1500, 1200 SEVENTEEN ST., DENVER, CO, 80202, US

(21) Appl. No.: 09/971,063

(22) Filed: Oct. 3, 2001

Related U.S. Application Data
(60) Provisional application No. 60/237,521, filed on Oct. 4, 2000.

(51) Int. Cl. G06F 19/00

(52) U.S. Cl. 700/97

(57) ABSTRACT

The present invention provides a computer system engineering methodology. The present invention uses an approach to engineering computer systems that includes a requirements workflow, an architectural workflow, a realization workflow, a validation workflow, and a project management workflow.

### RELATED APPLICATIONS

This application claims the benefit of U.S. Provisional Application No. 60/237,521, filed Oct. 4, 2000.

### BACKGROUND OF THE INVENTION

1. Field of the Invention

The present invention relates to a method and apparatus for the engineering of computer systems.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

2. Background Art

It is difficult to develop computer systems because modem computer systems are extremely complicated and the software may have millions of computer instructions. All of these instructions must interact with the computer system in a way that is predictable and error free. Usually the software and the system are developed by many people each separately working on different parts of the same project. It is very difficult to put together the pieces if each person uses a different style for developing their part of the system.

Complex systems are built by teams of people who work against a set of risks, uncertainties, and changing conditions. Complexity—unmanaged—is a barrier whose effects include an ever-increasing level of effort to enhance a system or fix its bugs. Complexity defeats the ability of any one person being able to grasp the big picture and reason through cause and effects. Changes to an overly complex system become extremely risky when done in an ad-hoc manner.

Even with extensive up-front effort, end users may not be able to fully describe what they want until they start seeing the result. Even with perfect initial requirements, some amount of ongoing change is inevitable. Business conditions change, and the end users redefine their needs based on new competitive pressures or opportunities. Even ignoring the external landscape, internal politics will result in new pressures to change. Even with no politics, the technology available changes and the design team changes. Sometimes computer systems are built on the fly. The class of applications that can be built that way, however, is diminishing. Increasingly, the demand is for more sophisticated applications that require a sophisticated methodology before the engineering begins.

Development in an Internet Environment

The Internet is driving down the cost of interconnections leading to new emphases on interoperability and interdependency. Characteristics of typical Internet applications include the need to support large numbers of users in which peak loads can be an order of magnitude greater than typical loads; selectively expose critical information across a physically insecure network; unify and simplify information and business processes in order to appeal to untrained and impatient users; build new connections to support new business partnerships; and quickly deploy and evolve solutions.

Invariably experienced developers, managers, and integrators incorporate a more-or-less systematic approach to their work. A methodology, or process, attempts to weave together what is generally considered the best of these procedures, guidelines, templates, and rules-of-thumb. The benefits of recording, standardizing, and reapplying a process are that they allow for: a common vocabulary; agreed-upon checkpoints; easily recognizable organizational principles and responsibility assignments; a repository of best practices of knowledge and experience; and a training vehicle.

The primary drawback of a process occurs when its activities draw too much work effort away from the production of a working system. There is a point, before which process is lacking and beyond which there are diminishing returns and even counter productivity.

### SUMMARY OF THE INVENTION

The present invention provides a method and apparatus for computer system engineering. The present invention includes a requirements workflow, an architectural workflow, a realization workflow, a validation workflow, and a project management workflow.

In one embodiment, the requirements workflow is designed to reach an understanding of what is to be built. It implements use cases in the form of use case diagrams and use case reports. The requirements workflow is constrained by business rules and system qualities, and includes supplementary requirements, priorities, and a project plan.

In another embodiment, the architecture workflow expands on the requirements workflow and sets a plan that can be implemented using platform dependant components. The architecture phase includes an application layer, an upper platform layer, a lower platform layer, and a hardware layer. Architecture is a set of structuring principles that enables a system to be comprised of a set of simpler systems each with is own local context that is independent of but not inconsistent with the context of the larger system as a whole. The process of architecture is a recursive application of structuring principles in this manner. Architecture ends and design begins when the remaining subsystems can be purchased or built in relative isolation to one another in a manageable timeframe by the available resources.

In another embodiment, the realization workflow is used to transform well defined units into working and tested code. The validation workflow is used to verify the correctness of the realizations relaxed to requirements and across the macro elements of the architecture. The project management workflow is used to make estimates, construct plans, and track projects to plans.

### BRIEF DESCRIPTION OF THE DRAWINGS

These and other features, aspects and advantages of the present invention will become better understood with regard to the following description, appended claims and accompanying drawings where:

FIG. 1 is a diagram representing stable intermediate forms

FIG. 2 shows the use of phases according to an embodiment of the present invention.

FIG. 3 shows the use of phases according to another embodiment of the present invention.

FIG. 4 shows the use of a requirements workflow according to an embodiment of the present invention.

FIG. 5 shows all of the workflows used by one embodiment of the present invention.

FIG. 6 shows an embodiment of the requirements workflow according to the present invention.

FIG. 7 shows the requirements workflow according to another embodiment of the present invention.

FIG. 8 shows the requirements workflow according to another embodiment of the present invention.

FIG. 9 shows an architectural workflow according to an embodiment of the present invention.

FIG. 10 is a block diagram showing the role of architecture according to an embodiment of the present invention.

FIG. 11 is an example of a container/component architectural specification according to an embodiment of the present invention.

FIG. 12 is an embodiment of a software architecture document according to the present invention.

FIG. 13 is an embodiment of a software architecture document having architectural views according to the present invention.

FIG. 14 is a flowchart showing the operation of an embodiment of the present invention.

### DETAILED DESCRIPTION OF THE INVENTION

The invention is a method and apparatus for computer system engineering. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Computer System Engineering Methodology

A computer system engineering methodology according to the present invention addresses the balance between the need for an engineering process and the point of diminishing returns by defining essential practices common across any project. The present invention is use-case driven, which provide a means for capturing requirements, organizing activities, and keeping the entire team focused on the end result. The central technical activity of the present invention is architecture, which is developed and validated early, and the rest of the system is built around it. The present invention is iterative and incremental where the bigger system is evolved from a series of smaller systems, each of which extends the other.

The most successful development activities result from breaking up a bigger thing into smaller things, reasoning about the relationships between those things, and then moving on to the smaller things. This is referred to generally as stable intermediate forms. Complex systems will evolve from simple systems much more rapidly if there are stable intermediate forms than if there are not. Most object oriented enthusiasts will recognize intermediate forms as embodied in objects. The same reasoning can be applied at successively larger levels of granularity, through packages, subsystems, etc. Intermediate forms also exist along the time dimension, as a system is built incrementally by layering functionality around an existing simpler system.

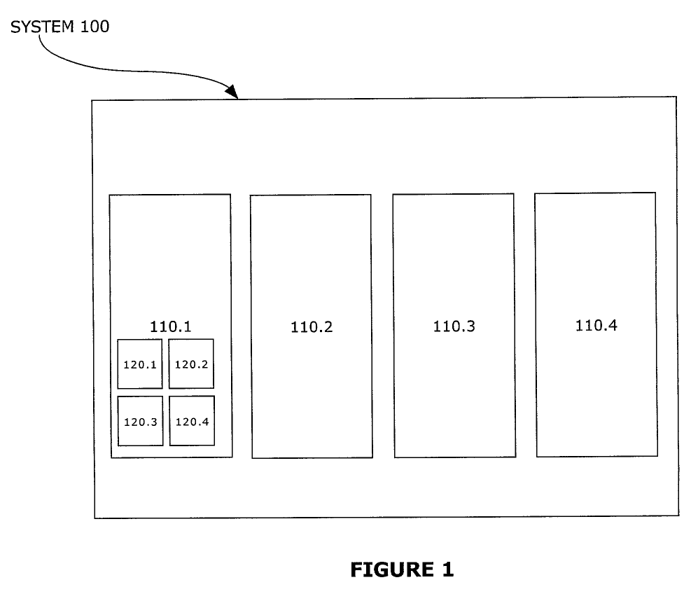

This notion is shown in FIG. 1, where an entire system 100 is shown as comprising stable intermediate forms 110.1, 110.2, 110.3, and 110.4. Stable intermediate forms 110 may also be comprised of smaller stable intermediate forms 120.1-120.4, shown as a component of 110.1. The process of having smaller and smaller intermediate forms may continue indefinitely until the desired level of granularity is reached. Before further discussing this concept, several key definitions are outlined.

Process

A process outlines the workings of a team-oriented approach to specifying, constructing, and assembling software and hardware components into a working system that meets a well defined need. This includes aspects such as who performs certain activities, what artifacts they generate from those activities, for who are the artifacts generated, when activities are performed and when artifacts are completed or checklisted, why activities are done a certain way, or artifacts are formatted a certain way, or various emphases are stated a certain way, and how something is done in the form of recommendations, guidelines, checklists, or patterns.

Stakeholder

A stakeholder is any person who has an interest in the outcome of a project. An individual can furthermore play any number of stakeholder roles. Stakeholder roles can be categorized in terms of their overall relationship to a project. In the first category are those who are affected by what the working system will do when it is completed. A separate category describes those who are concerned with what the system requires to operate on an ongoing basis. The last category considers those who construct the system in the first place.

Artifacts

Artifacts are things that are produced. This could refer to a single class or type, a package, a model, or the whole design model, for instance. A document is an aggregate artifact suitable for printing. Most commonly, the term artifact is used to reflect the larger or aggregate variants that might be specifically identified as project deliverables. Artifacts can be classified to the degree that they are exposed to user communities. The external, or delivery, set is the system itself in executable form along with associated supporting materials such as user documentation and installation guides. The extension set describes advanced features for extending the system, and may or may not be exposed to end users but if so is usually for a subset of more skilled users.

The internal set is only of interest to those building or maintaining the system. The internal set has the most variety of forms, including various plans, architecture and analysis and design models, code documentation, etc. Some internal artifacts may be constructed for a transitory purpose (i.e., thrown away). Lasting artifacts must have a stakeholder willing to keep them up-to-date on an ongoing basis, and a stakeholder who consumes the information they provide.

Internal artifacts tend to be produced early, perhaps first in outline form and refined through experience. External artifacts tend to be produced later, and extension artifacts somewhere between. However, for systems that provide novel functionality from an end-user perspective, it can sometimes be useful to produce external artifacts much earlier. For example, a user manual might be produced describing a system that allows its rules to be manipulated in some way. A conceptual prototype can serve a similar purpose. A conceptual prototype is an internal artifact used for demonstrating concepts to end users and getting their feedback It is usually intended to be throwaway, rather than evolutionary.

Phases

At any given time, any kind of activity could be going on within a project, but at different times, the maximum payoff comes from being focused on key issues. The partitioning of the project timeline into phases serves to clarify and emphasize these priorities both internally and externally to the project. Each phase is defined by the artifacts that constitute its deliverables, which in turn drive the activities that must occur within that phase.

The transitions between phases are also considered major milestones, and the ends of each phase are accompanied by a decision whether to proceed to the next phase. Four phases are defined for each product release, which proceed in order. Inception is the first phase, during which the scope of a project is defined, and its risks and major milestones are estimated. Understanding scope involves a certain amount of exploration and documentation of the system's requirements. Inception essentially involves putting some solid definition around the idea of what the system should do, what it will take to get there, and how to know when and if success has been achieved. Elaboration follows inception. Elaboration has two primary threads, one that focuses on architecture and the other on fleshing out requirements that were outlined mostly breadth-first in inception.

Construction follows elaboration. This is where the bulk of functionality is built on the stable foundation established in elaboration. More and less senior team members can be added for this purpose, since the predictability and foundation established during elaboration ensures that economies of scale can be achieved. Transition is the final stage, during which the system is first put in the hands of users and finalized in preparation for release. Transition usually begins with a beta test period and ends with an official system release.

Within phases work is organized in terms of iterations. Iterations provide a way of treating system development as many small releases (internal or external) in place of one big release. Each iteration produces an executable mini-release, built upon the release of the previous iteration, such that a system is grown toward its target. The advantages of building by iterations include: a unified focus across teams; early customer feedback; continuous integration and test, which uncovers risks sooner, makes progress measurements more accurate, and offers the possibility of an early release.

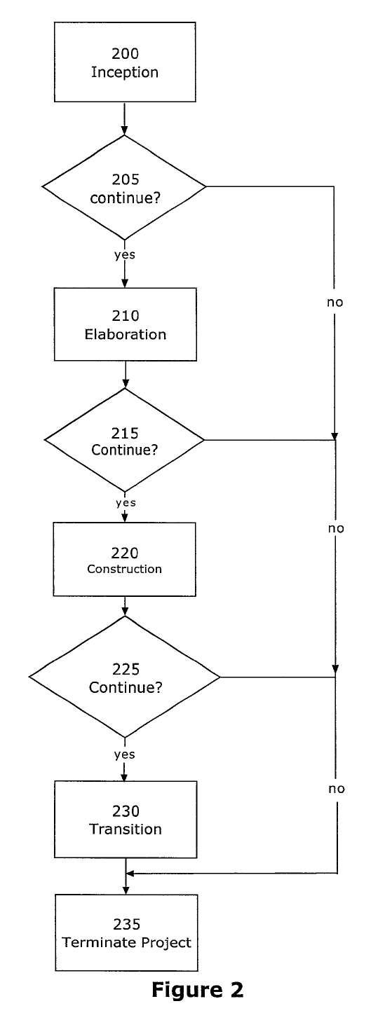

FIG. 2 shows a diagram of the phases used by an embodiment of the present invention. At block 200 an inception phase takes place. At block 205, it is determined if the project should continue. If not, the project terminates at block 235. Otherwise, at block 210, the elaboration phase occurs. After the elaboration phase, it is determined at block 215 if the project should continue. If not, the project terminates at block 235. Otherwise, at block 220, the construction phase takes place.

After the construction phase, it is determined at block 225 if the project should continue. If not, the project terminates at block 235. Otherwise, at block 230, the transition phase occurs. After the transition phase, the project terminates at block 235.

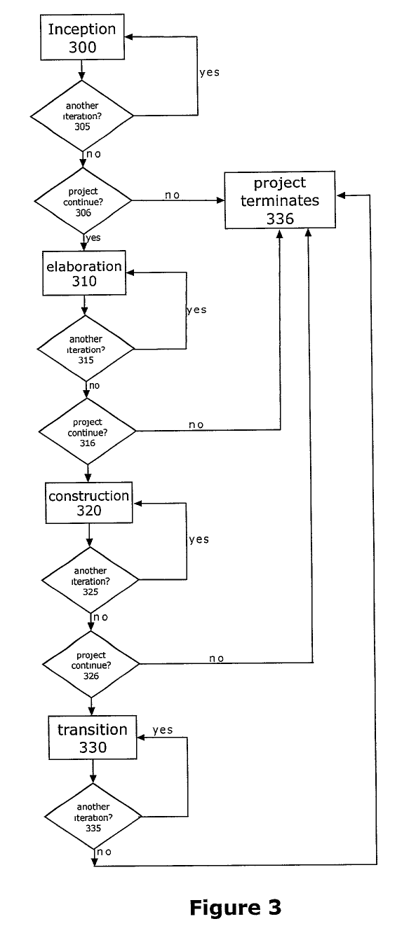

FIG. 3 shows a diagram of the phases used by an embodiment of the present invention. At block 300 a portion of an inception phase takes place. At block 305, it is determined if another iteration in the inception phase should take place. If so, block 300 repeats. Otherwise it is determined if the project should continue at block 306. If not, the project terminates at block 335. Otherwise, at block 310, a portion of an elaboration phase occurs. At block 315, it is determined if another iteration in the elaboration phase should take place. If so, block 310 repeats. Otherwise, it is determined at block 316 if the project should continue. If not, the project terminates at block 335. Otherwise, at block 320, the construction phase takes place.

After an iteration of the construction phase, it is determined at block 325 if another iteration is required. If so, block 320 repeats. Otherwise, it is determined at block 326 if the project should continue. If not, the project terminates at block 335. Otherwise, at block 330, the transition phase occurs. After an iteration of the transition phase, it is determined at block 335 if another iteration is needed. If so, block 330 repeats. Otherwise, the project terminates at block 336.

Workflows

The activities involved in building a system tend to be cohesive in terms of their interactions with other activities as well as the artifacts that are produced as a result. These groupings are called workflows. The entirety of a given iteration's work can be partitioned across well-defined workflows. With some exceptions at the ends of a project, each workflow is more or less active within each iteration.

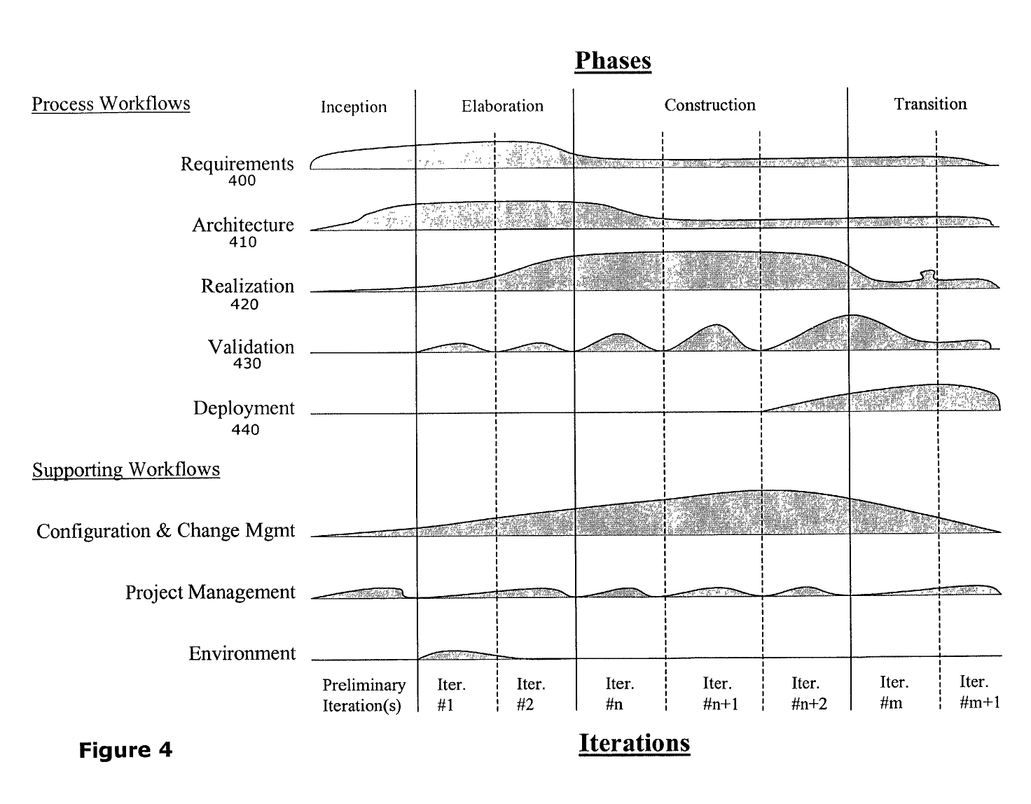

As the project progresses, the relative amount of expended effort in each workflow varies as illustrated in FIG. 4. The requirements workflow 400 needs considerable effort at the beginning. The architecture workflow 410 requires considerable effort in the elaboration and construction iterations and then remains constant for the remainder of the project. The realization workflow 420 is very active in the construction phase and requires less effort elsewhere. The validation workflow 430 spikes in effort with each iteration. The deployment workflow 440 requires effort only in the concluding iterations of the project.

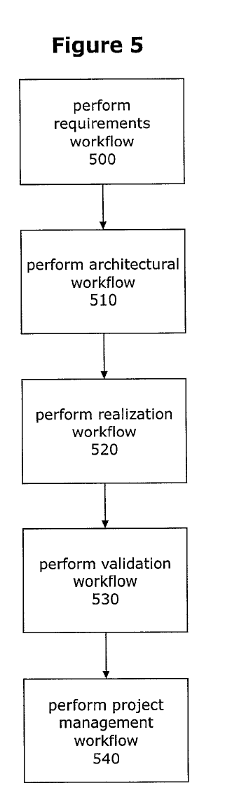

FIG. 5 shows the operations taken by embodiments of the present invention that include a requirements workflow, an architectural workflow, a realization workflow, a validation workflow, and a project management workflow. At block 500, a requirements workflow is performed. At block 510, an architectural workflow is performed. At block 520, a realization workflow is performed. At block 530, a validation workflow is performed. At block 540, a project management workflow is performed. Each of the workflows defined in the blocks of FIG. 5 are expanded below.

Requirements Workflow

For any computer system, typically, there are many users as well as many builders, and often the users cannot articulate or agree on a well defined set of goals and priorities. Requirements management is a primary factor in the success or failure of development projects. Some of the characteristics of good requirements are that they are: clear and unambiguous, complete, correct, understandable, consistent (internally and externally), concise, and feasible.

It is important to consider that multiple diverse audiences should buy in to the requirements. Notably this includes those who will use the system and those who must build it. The language should be readable by both, and exclude considerations not of interest to both. Use cases provide a structuring approach along these lines for the functional aspects of a system. Various supplementary requirements complete the description. Some requirements are functional in nature, described from the perspective of a user along the lines of “this happens then that happens”. Other requirements are systemic in nature, and affect many use cases.

Some systemic requirements describe a business independently of the system under consideration. These are business rule requirements. Other systemic requirements describe what the system entity must do to fit into various business, management, and operational processes. These are the systemic quality requirements. Finally, any other non-domain oriented constraints such as “you must use database X because we own a license” are referred to as supplementary requirements. The term non-fractional requirements aggregates all the non-use-case forms of requirements.

Some systemic quality requirements may also be described in use case format. When this issue is important, 1^{st}-order functional requirements are distinguished from 2^{nd}-order functional requirements. The latter are system quality requirements described as use cases. Examples include manageability as well as advanced mechanisms built in to the system to enable it to be modified quickly.

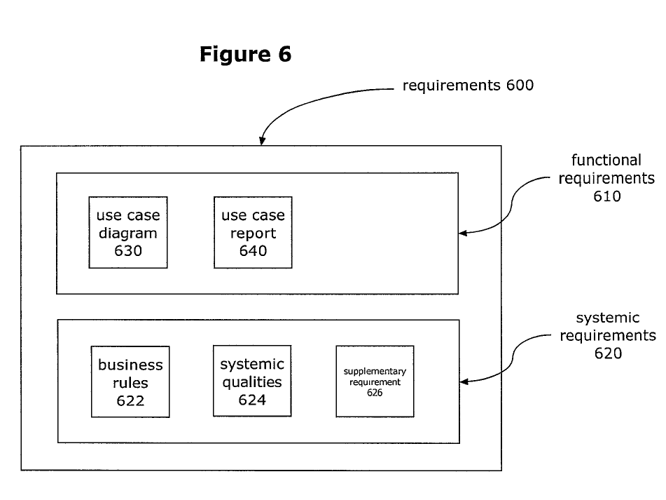

FIG. 6 shows one embodiment of a requirements workflow. Requirements 600 is comprised of functional requirements 610 and systemic requirements 620. Systemic requirements 620 include business rules 622, systemic qualities 624, and supplementary requirements 626. Functional requirements 610 is comprised of use cases 620. Use cases are techniques for describing functional requirements in terms of generic usage scenarios with respect to one or more actors. Actors are roles external to the system, where a role may be played by one or many persons, external systems, or devices. A use case describes the interaction between an actor(s) and the system whereby that actor(s) receives some benefit from the system. Taken as a whole, a set of use cases describes what the system does.

Use cases are described at two levels in FIG. 6. A use case diagram 630 uses a limited set of icons to visually diagram the relationship among actors and use cases. This is particularly helpful when either there are many-to-many relationships among actors or use cases, or there are additional relationships among actors and use cases themselves. Such relationships typically become more useful as a use case model starts to stabilize.

In addition to the view across use cases provided in the use case diagrams, individual use cases are described in more detail in use case reports 640. These describe the regular and alternative flows of events in the use case, commonly as more or less informal text, and sometimes annotated with models or user interface specifics when appropriate. There is no standard syntax for the descriptions or even the overall structure of use case reports, although several common variants are known to those skilled in the art.

The present invention is use case driven, which means that functional requirements 610 are organized as units (use cases) that can be added/removed in blocks. The entire project is responsible for demonstrating functional use cases at regular (not too long) checkpoints. These checkpoints are also called iterations.

Business Rules

Most systems have a complex internal state which has pre-defined structures governed by a set of constraints. The entities of this structure form the nouns of use cases. However, many of these constraints remain invariant across and independent of the use cases that reference them and are therefore awkward to put in use case descriptions. For this reason they are a distinct form of requirements which are represented separately from use cases.

Often, business rules can be captured in visual form, using available UML models. Not all business rules, however, are amenable to visual representation. Visual models should be extended with textual notations for this purpose. Formal (such as UML's OCL) or informal languages can be used for this purpose, depending on the complexity and the target audience.

A domain object model (DOM) collectively refers to the set of business rules, however specified. The DOM is independent of implementation, and should be able to be understood by a domain expert who is comfortable with the notation yet understands nothing about implementation. If such domain experts are not available, it is reasonable to incorporate separate DOMs for consumption by domain experts vs. internal developers. The external DOM incorporates simple UML elements. The simplest form of DOM is simply an enumeration of primary entities and their descriptions, called an essential entities list. The essential entities list also serves as a reasonable first cut at a more detailed domain object model.

Systemic Qualities

Systemic qualities reflect current and evolving goals for the system as it fits into an operational and business environment. Manifest qualities are systemic qualities that reflect what individual end users see. Usability is a manifest quality that reflects the ease which users can accomplish their goals. Performance is a manifest quality that reflects how little users must wait for things to complete. Reliability is a manifest quality that measures how often the system fails. Availability is a manifest quality that provides for graceful degradation in place of total failure. Accessibility is a manifest quality that incorporates usability paradigms for those with physical limitations.

Operational qualities are systemic qualities that concern those who run or monitor the system as it operates. Throughput is an operational quality that measures how many users can be supported before they perceive intolerable performance. Manageability is an operational quality that is a form of usability for operations support staff, including the ability to start or stop, monitor, tune, and otherwise control the system. Security is an operational quality that restricts and holds accountable those who are able to see and do various things. Serviceability is an operational quality that facilitates routine system maintenance.

Developmental qualities are systemic qualities that describe advantageous aspects of the system of interest to its developers as it is being built. Buildability is a developmental quality that refers to the amount of effort required to build the system in a given time frame. Planability is a developmental quality that reflects the degree to which a predictable plan and cost estimation can be created.

Evolutionary qualities are systemic qualities that anticipate future needs beyond the current release. Scalability is an evolutionary quality that refers to the ratio between the ability to support more users vs. the amount of required effort. Maintainability is an evolutionary quality that eases the work of minor modifications and fixes. Flexibility is an evolutionary quality that makes significant enhancements or changes easier. Reusability is an evolutionary quality that allows portions of the current system to be incorporated into other systems.

More often than not, these qualities reinforce or in some cases counteract one another. In other words, any given pair from the list above is likely to relate to each other in some way. For this reason, careful attention should be paid to prioritizing the list. While few of these system qualities will be considered as expendable in isolation, the encompassing business system should be able to compensate at least for a while. For example, an organization might be willing to live with a laborious backup procedure for the first release in the interest of getting the system out earlier. Such decisions should be driven by all appropriate stakeholders and while not all issues may be apparent up front, a concerted effort to define priorities establishes a methodological foundation for handling contingencies as they arise.

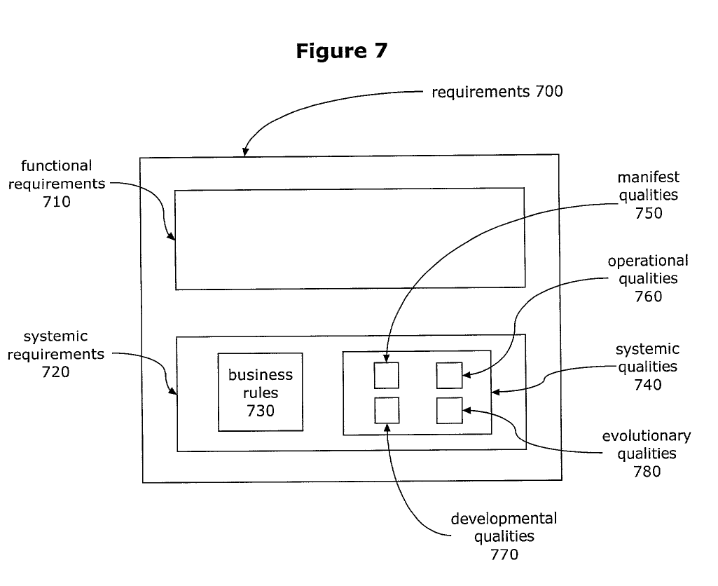

FIG. 7 shows another embodiment of a requirements workflow according to the present invention. Requirements 700 comprises functional requirements 710 and systemic requirements 720. Systemic requirements 720 includes business rules 730 and systemic qualities 740. Systemic qualities 740 includes manifest qualities 750, operational qualities 760, developmental qualities 770, and evolutionary qualities 780.

Priorities

With a complete set of requirements, one is able to understand how a system should behave. There are also additional constraints that work against progress. In this context, establishing priority among goals is helpful. Priority begins with business processes, addressing issues such as: a justification of which business opportunities or threats are addressed by the system under consideration; which business processes are most affected; what are the features and qualities that will have the most business impact; and who are the primary stakeholders whose influence should be considered paramount

These issues are documented in the project's vision document. Importantly, this is separate from the requirements document itself. The latter may be lengthy and detailed and therefore may be unlikely to be read by all key stakeholders, especially upper management. The vision document, on the other hand, should be considerably shorter and is signed off by the project's key stakeholders.

Incremental Reinforcement

The requirements workflow involves creating key artifacts including:

a product vision document to rally key stakeholders around the principle requirements;

a glossary to uncover multiple meanings for the same terms, and to educate the rest of the technical staff;

a requirements document to reach an understanding of what is to be built in its functional aspects (i.e., actors & use cases, lists & details), system qualities, business rules, domain object models (DOM), and supplementary requirements;

a risk list for prioritizing activity; and

a project plan for identify major & minor milestones.

These are all started in inception, although most of the contents may be filled out during elaboration. For the most part, there is little difference in the listing of artifacts between inception and elaboration. It is more a matter of level of detail as illustrated in Table 1. Requirements artifacts should be stable after elaboration, excluding the fleshing out of non-risk related detail or unexpected considerations that may (are likely to) arise.

TABLE 1

| | Inception | Elaboration |
|---|---|---|
| Product vision | Baselined, Inability to reach | May have to make significant |
| | agreement on core issues may | adjustments based on lessons |
| | call for extended inception to | learned. |
| | define scope. | |
| Functional requirements | All known use cases | Use cases detailed at 80% or |
| | identified, allowing for some | more, excluding mechanical |
| | expected growth. Some use | detail with no impact on |
| | cases are detailed. | project risk. |
| System quality requirements | Primary goals articulated for | Refinement based on derived |
| | primary qualities including | requirements and experience |
| | scalability, security, | gained during prototyping. |
| | availability and evolutionary | |
| | requirements. | |
| Supplementary requirements | Baselined. | Updated as needed. |
| Domain object model | An essential entities list can | Baselined, mostly complete, |
| | suffice. | able to handle complex cases. |
| Risk List | Complete based on current | Shrinking risk list after |
| | knowledge. | mitigation strategies affected. |
| Project Plan | Major milestones estimated. | Major and minor milestones |
| | | estimated. |

scalability, security, gained during prototyping.

There are few ordering relationships among these artifacts, in terms of which should be developed before others. A good portion of the overall vision is established relatively early and that the plan is generally completed last, but most of the artifacts can be developed in a circular and reinforcing manner. This reinforcement is outlined in Table 2, in which the row labels represent inputs and the column labels outputs, most of which are also inputs.

TABLE 2

| | | | | Use Case | Use Case | |
|---|---|---|---|---|---|---|
| | Glossary | Actors | Key Entities | List | Detail | Risk List |
| Glossary | | Contains actor | Contains less- | Many glossary | Cross check for | |
| | | definitions. | detailed entity | items should be | completeness. | |
| | | | descriptions. | accounted for at | | |
| | | | | least once in | | |
| | | | | some use case. | | |
| Actors | Also in | | Each actor can | The collective set | The training, | Actor |
| | glossary, but | | often be | of things each | frequency of use, | attributes can |
| | has additional | | described as | actor does | physical location, | define risk, |
| | detail. | | creating, | constitute the set | and other actor | e.g. low |
| | | | reviewing, or | of use cases. | attributes | performance |
| | | | updating key | | influence this | tolerance. |
| | | | entities. | | detail | |
| Key | Should also be | Each entity must | | Each entity | Check each use | Complex |
| Entities | in glossary, | be of use to | | requires sets of | case against each | models can |
| | perhaps with | some actor. | | use cases to make | key entity. | reflect |
| | less detail. | | | them useful to a | | technical risk. |
| | | | | business process. | | |
| Stories | Domain words | Each story has | Each story | Each story is part | Dries one or | |
| | should be | at least one | usually has at | of some use case. | more scenarios. | |
| | defined. | actor. | least one key | | | |
| | | | entity. | | | |
| Use Case | Consideration | A concrete use | Most use cases | | Balances scope, | Breadth |
| List | of naming | case should not | touch at least | | insofar as out-of- | identifies |
| | results in new | exist without at | one key entity. | | scope details | schedule risk. |
| | glossary | least one actor. | | | relative to a given | |
| | entries, | | | | use case are | |
| | | | | | accounted for in | |
| | | | | | some other use | |
| | | | | | case in the list. | |
| Use Case | Uncommon | New actors may | New entities | May lead to | | Complex |
| Detail | terms should | become | may become | better | | details |
| | be added to | apparent. | apparent. | understanding of | | identify |
| | glossary. | | | domain, helping | | technical |
| | | | | to uncover more | | risks. |
| | | | | use cases. | | |
| Risk List | | Mitigation | Mitigation | Mitigation | Need to | |
| | | strategies can | strategies can | strategies can | understand risk | |
| | | redefine and/or | redefine and/or | redefine and/or | drives some | |
| | | shorten targeted | shorten targeted | shorten targeted | detailed | |
| | | actors. | entity areas. | functionality. | exploration early. | |

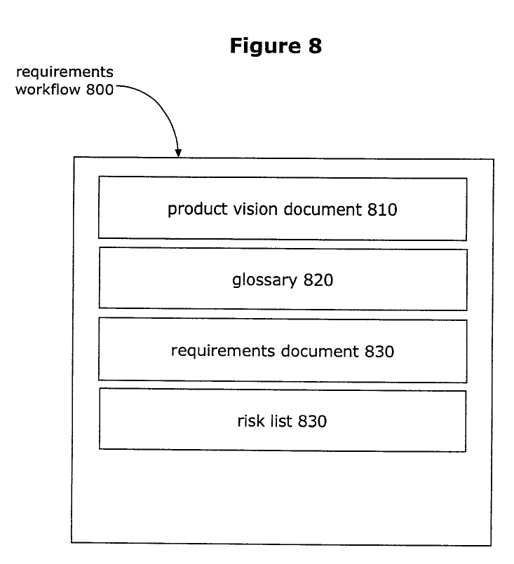

Among the inputs along the left-hand side of Table 2 are stories. Stories are natural way of collecting requirements from business users. Many people are comfortable with describing their vision of a system in a narrative way. Stories ultimately are parsed into use cases, and are not therefore in the output list along the top of Table 2. FIG. 8 provides a diagram of a requirements workflow according to one embodiment of the present invention. Requirements workflow 800 includes a product vision document 810, a glossary 820, requirements document 830, and a risk list 840.

Architecture Workflow

Real-world projects have not only functional, but also non-functional requirements that are complex and challenging. Multiple people are involved in the evolution of the system, which may go through many phases and releases. Requirements are changing along the way. While requirements problems are usually the cause of immediate failure, architecture problems are usually the cause of problems that occur after release. Increasingly there are options to buy commercial components to make the job easier. Still, however, considerable design, planning, and oversight are required to bring it all together.

The following is a proposed definition of architecture: A system is a group of interrelated and interacting elements providing a set of functionality in a context. Context includes the non-functional characteristics of the system, as well as the requirements the system in turn has of its environment. Architecture is a set of structuring principles that enables a system to be comprised of a set of simpler systems each with is own local context that is independent of but not inconsistent with the context of the larger system as a whole. The process of architecture is a recursive application of structuring principles in this manner. In a software system, architecture is said to end and design begun when the remaining subsystems can be purchased or built in relative isolation to one another in a manageable timeframe by the available resources.

It is common to think of a system just in terms of its functionality, no system operates in isolation. For example, a car might be able to accelerate from 0 to 60 in 6.6 seconds, but not on a steep dirt mountain road. If the system is defined as encompassing the car and the roads then it can be controlled how and where the roads are built, but this new system would still require terrain with no gradient greater than 1%. The context of a system is its dependencies when considered outside of a certain scope.

Architecture is a set of structuring principles that enables a system to be comprised of a set of simpler systems each with is own local context that is independent of but not inconsistent with the context of the larger system as a whole. A structuring principle is a decomposition step which is motivated to satisfy a set of goals and constraints at a certain level of abstraction; documented where its motivations and specifications are not implicitly clear; and specified as (a) a set of distinct and usually lower-level functionality embodied in smaller subsystems, and (b) the relationships and interactions between those subsystems.

The key to architecture is the decomposition of a whole into smaller parts. Each subsystem in turn has assigned responsibilities and a context. The needs of the larger system define nonfunctional requirements on each subsystem. For example, if a system must perform an operation in no greater than 1 second, then it might require that each of its three subsystems each perform their sub-operation in greater than ⅓ of a second.

The development and maintenance of a system is enhanced when the collective requirements of a subsystem are defined in a way that the builder of a subsystem would be unable to make a local decision that conflicted with a goal of the larger system. If a designer of an individual system component were to make global decisions addressing non-functional requirements, those decisions would be unlikely to be optimal or even correct. For example, scalability addresses the need to support a certain number of users. Much like a chain, the system's scalability is limited by its weakest link. It is not cost efficient to make one link stronger while other links remain weak. Instead, an overall balance is achieved in the definition of the larger system and the manner which it distributes responsibilities across the subsystems.

The process of architecture is a recursive application of structuring principles in this manner. In a software system, architecture is said to end and design begun when the remaining subsystems can be purchased or built in relative isolation to one another in a manageable timeframe by the available resources.

Architecture is controlled by one or a few individuals with a big-picture view, and design is controlled by many (often less senior and/or less skilled) people without the big-picture view. Architecture should be taken by the few far enough to allow the many to be effective toward making the system achieve its overall goals. In this way, each level of decomposition is a simplifying reinterpretation of the larger systems requirements. This process may be applied recursively until the system has been redefined in terms of buyable or build-able piece-parts which when placed together will form the system as a whole. The wholeness of the many piece parts is the architecture. Non-architectural design is that which supports a set of functional requirements by making local decisions which cannot violate the non-functional requirements of the system overall, because it adheres to the architecture.

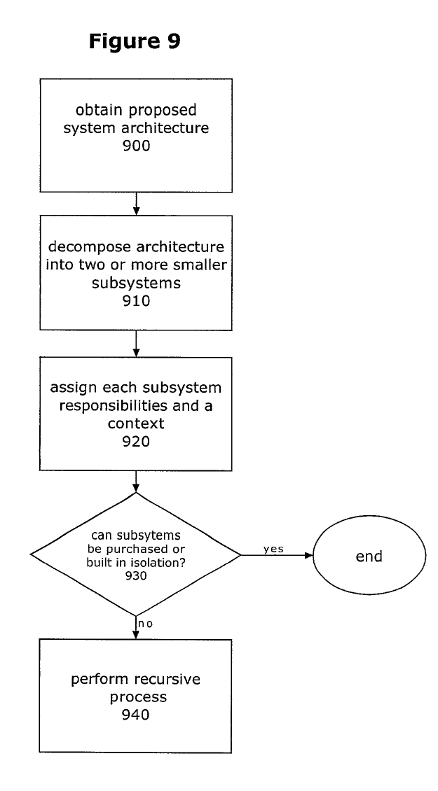

FIG. 9 is a flowchart showing the architecture workflow according to one embodiment of the present invention. At block 900, a proposed system architecture is obtained. At block 910, the architecture is decomposed into two or more smaller sub-systems. At block 920, each subsystem is assigned responsibilities and context. At block 930, it is determined if the smaller sub-systems can be either purchased or built in relative isolation under a manageable timeframe. If so, the architecture workflow is complete and the process ends. If not, a recursive process is followed at block 940 where each sub-system is broken into a smaller sub-system and block 910 repeats.

Better Decomposition

Table 3 shows several advantages to performing a decomposition:

TABLE 3

| | | Description | Architectural Relevance |
|---|---|---|---|
| A | 1 | Layering according to some ordering principles, typically | Code at lower layers tends to be |
| | | abstraction. The layers may be totally or partially ordered, such | further removed from the eventual |
| | | that a given ordering tuple {x.y} indicates that x uses the services | application and hence more |
| | | of y, and x in turn provides a higher-level services to any layer | reusable and purchasable. Skill- |
| | | uses it. | sets and domain expertise for |
| | | | building components at the lower |
| | | | layers is often very different from |
| | | | higher layers. |
| | 2 | Distribution among computational resources, along the lines of | Distribution is a primary |
| | | one of the following: | technique for building scalable |
| | | 1. Dedicated tasks own their own thread of control, | systems. Since the goals and |
| | | avoiding the problem of a single process or thread going into a | structure of processes/threads is |
| | | wait state and not being able to respond to its other duties. | often orthogonal to other aspects |
| | | 2. Mobility allows (but does not require) the resulting pieces | of a system, it typically cuts |
| | | can to run on separate devices and communicate with each other | across many subsystems and is |
| | | (if necessary) over a remote protocol. Variants include: | therefore often difficult to manage |
| | | a. Static mobility, in which the mapping from logically | if it is buried deep in a system's |
| | | remotable parts to physical resources is done when the system is | structure. |
| | | down, possibly with some small amount of code change required. | |
| | | b. Dynamic mobility (agents), which is the ability for a unit | |
| | | to move at runtime in which case it may not itself make use of a | |
| | | remote protocol, but get moved over one without its direct | |
| | | knowledge. | |
| B | 3 | Exposure to other units. Any given computational unit | Remotable units, typically at the |
| | | fundamentally has three different aspects, and for complex units | tier level, involve different |
| | | these may be broken apart into several pieces: | architectural mechanisms at these |
| | | 1. Services, or what the unit offers | levels. |
| | | 2. Logic/implementation, or what the unit does internally | |
| | | 3. Integration, or how the unit accesses other units. | |
| | | Wrapers or adaptors components fit into this category, insofar | |
| | | Asphaltmischwerk they make somebody else's extemal paradigm | |
| | | fit into our intemal paradigm. | |
| | 4 | Functionality of the problem space. For example, the Order | Primary architectural concem is |
| | | module, the Customer module, etc. | for 2^{nd} order and non-functional |
| | | | requirements; only high-level or |
| | | | indirect concem with 1^{st} order |
| | | | functional requirements. |
| | 5 | Generality across projects. Some parts of the system will be | Reuse of custom or COTS |
| | | usable in that system only, some parts are intended be reused | components is often considered a |
| | | elsewhere, some parts are being reused from elsewhere, some | primary ingredient in achieving |
| | | parts are purchased, etc. From another perspective, some parts of | greater efficiency and lower costs. |
| | | the system are more specific to the problem space being | However, these benefits can only |
| | | addressed, while some parts are more general across application | be achieved if the expense of |
| | | domains. Within the bounds of a single system, reusability is akin | working around a thing is less |
| | | to sharing, which is often accounted for in layering, | than the expense of building it in |
| | | | the first place. |
| C | 6 | Coupling & cohesion, as in low coupling and high cohesion. | Unmanaged dependencies across |
| | | things that work together should be together (high cohesion), | code units can lead to systems |
| | | while things which work together less often (low coupling) might | which are complex to understand |
| | | set apart. | and maintain, and for which |
| | | | changes and fixes effect multiple |
| | | | units and are correspondingly |
| | | | expensive. |
| | 7 | Volatility and variability. Isolate things that are more vs. less | Somewhat like coupling & |
| | | likely to change, or things that simply change on different | cohesion based on the likelihood |
| | | schedules. In most systems, for example, the GUI changes more | of being changed at the same |
| | | often than the underlying business rules (although the opposite | time. Anticipating change can |
| | | may be true for some systems), especially when the need for | facilitate change. |
| | | internalization and localization is taken into account. | |
| D | 8 | Configuration options. If the target system must support different | Like having multiple architectures |
| | | configurations (for pricing, usability, performance, security, etc.), | with a shared core. |
| | | the system will have to reflect configuration-specific parts vs. | |
| | | shared (across configuration) parts. | |
| E | 9 | Planning and tracking. An attempt to develop a fine-grained | The Project Manager relies on the |
| | | project plan usually has two key considerations (there are other | architect to define the system at |
| | | considerations in the planning process but for the moment we are | an appropriate granularity around |
| | | focused just on the issues which drive us to decompose the | which a plan can be built. |
| | | system); | |
| | | 1. Ordering by dependency (package B is dependent on A, | |
| | | so A should probably be done first). A good system has few if any | |
| | | bi-directional or circular dependencies. | |
| | | 2. Size (break a big thing apart so that the project plan can | |
| | | be defined in smaller time units against the smaller parts). | |
| | 10 | Work assignment, based on various considerations, including: | Anticipates and determines the |
| | | 1. Physically-distributed teams | composition of teams for design |
| | | 2. Skill-set matching, e.g. web-developers vs. Java | and implementation. |
| | | programmers | |
| | | 3. Security areas. For classified work, only certain | |
| | | individuals must be allowed to access certain parts of the code. | |

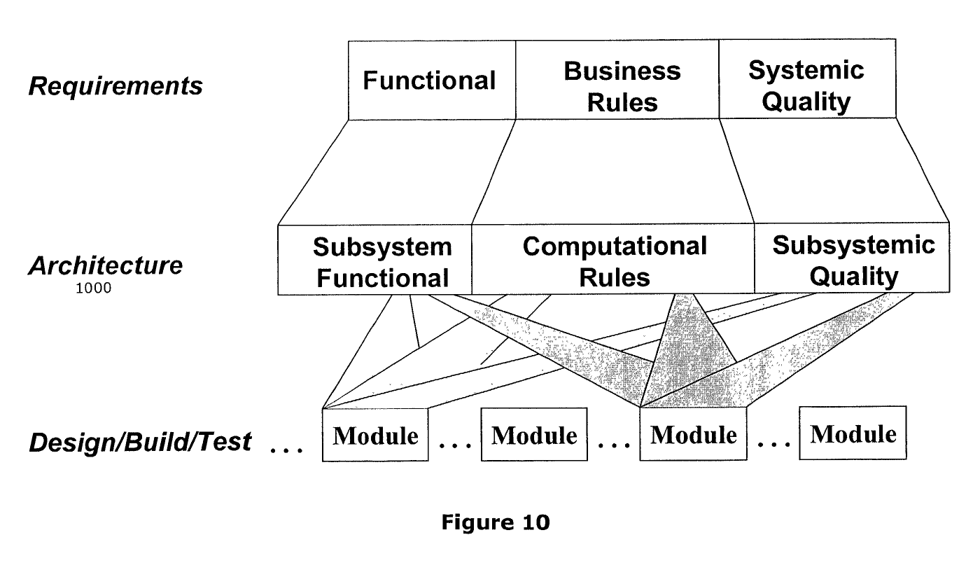

It worth noting that architecture is not an absolute decomposition, insofar as many forms of lower-level intermediate functionality are introduced so that higher-level functionality can be expressed in terms of them. As illustrated in FIG. 10, architecture 1000 expands and reinterprets system requirements so that individual design elements have to be exposed as little as possible to the overall picture. Designers build to a subset of functional requirements at their level, while being constrained by a subset of non-functional requirements at their level.

Fundamentals of Structure

One of the effects of decomposition is on the system structure as expressed in terms of packages, since this gets reflected in code and is what designers and implementers have to build on. The term ‘package’ is used in the UML and in platform independent programming languages, such as Java, to define a namespace with visibility rights. Packages can contain other packages, and can be contained in only one other package (even though, as a drawing convenience, the UML allows individual items to be “imported” into other packages). Package structure is inherently hierarchical.

The first column in Table 3 represents a partial ordering among packages based on subs. Heuristics associated with a lower letter may take into account, at a larger granularity, heuristics associated with a higher number. Conversely, heuristics associated with a higher number do not contravene the boundaries established by lower-letter heuristics. Within a letter group, different orderings may apply based on a variety of circumstances. Packages in the same group may be placed at the same level in the package hierarchy.

The ordering is not absolute because a project might have a good reason to make variances. For example, security areas is a variant of rule 10, but a project might call for it to applied as rule 1 in order to purposely completely obfuscate the internal structure of a security area. Nevertheless, the ordering in Table 3 provides a baseline against which variances if they are made should be documented.

A package is a kind of component, used in many of the definitions in Table 3. “Components” are generic. The Unified Process is more specific than most on its definition, emphasizing physical swapability on the one hand but also function and interface implementation on the other. The difficulty is that many things can be described as components, including a C language header file, a class definition, a runtime class instance, a layer, a database, and so on.

What is required is a means of clarifying a particular use of the term based on context. The container / component distinction defined in the Java 2 Enterprise Edition specification (J2EE) provides the base direction, and the concept is generalized here. A component is an entity that operates inside a container. A container is an operational environment for components. Containers and components are defined in terms of one another, one cannot exist without the other. The particular attributes of a component are entirely dependent on what kind of container it requires, and a component may in fact be described in several ways in the context of different containers.

A given component may be directly manipulable in some way and in turn delegate certain operations to its container, or it may be manipulable only through its container, or some combination of both. A file, for example, can be considered a component with respect to a file system container. A source file is a component with respect to a compilation system. An executable is a component with respect to a host operating system container. A Java Virtual Machine (JVM) is such a component, which in turn acts as a container for Java executables. A java class file is a component with respect to the class-loading container defined inside the JVM; once loaded, the executable code is a component with respect to the overall application runtime itself. Per the J2EE specification, a web browser or web server may act as an intermediary container/component between the JVM and an application instance, which can then be identified as an applet or servlet, respectively.

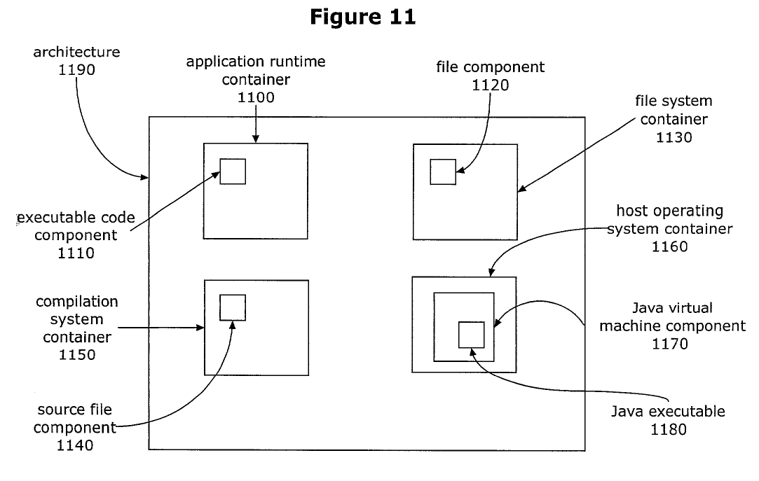

FIG. 11 shows one example of a container/component architectural specification. Application runtime container 1100 contains executable code component 1110. File component 1120 is in file system container 1130. Source file component 1140 is in compilation system container 1150. Host operating system container 1160 includes Java Virtual machine component 1170, which in turn is a container for Java executable 1180. All of the containers shown, in turn are contained by the entire architectural plan 1190.

Architectural Views

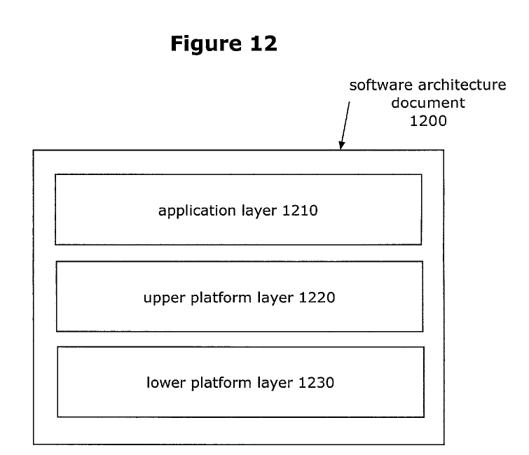

The architecture is described from different perspectives which are called views. The IEEE P1471 Architecture Planning Group defines a view as “A representation of a whole system from the perspective of a relaxed set of concerns”. The system layers provide a natural way to organize these views, which are presented as such in the following sections. Collectively these represent the content of the Software Architecture Document. An embodiment of the software architecture document is shown in FIG. 12. Block 1200 is the software architecture document. It is comprised of an application layer 1210, an upper platform layer 1220, lower platform layer 1230. The layers are described in more detail below.

Application Layer

The application layer comprises several views describing application-specific issues. These views are of interest to: the architect who must communicate and maintain architectural integrity; designers & maintainers to understand scope and context of subsystems, and proper use of mechanisms; the project manager in order construct and track plans around architectural structures and mechanisms; and any maintainer.

Application Layer/Structure View

This view captures the structure of the system. This is specified in terms of packages and the static dependencies among them. The containment relationship among packages is also shown. Containment is also (or will eventually be) evident in the file system directory structure, but the latter does not represent UML dependencies, which is a primary goal of this view.

UML properties, and/or other graphical highlighting, can be used to distinguish packages that represent reused (COTS or otherwise) packages, as well as custom packages that are intended to be reused. This view is used for applications that involve custom development. Each custom application should have its own architectural description that may refer back to the overall common infrastructure project for its lower layers.

Application Layer/Configurations View

Whereas the structure view shows static dependencies internally, the dynamic view shows dynamic dependencies among deployable components. Each collection of components represents a possible configuration variation. UML component diagrams, with dependencies among components, are used to illustrate configurations. The components are also overlaid on deployment diagrams. As UML allows components or deployment nodes to represent classes or specific instances, certain levels of generality are achieved for situations involving multiple diverse configuration variations.

A configuration represents an assemblage of components that can be executed without linking errors at any time during its execution. A configuration is defined by it components and their dependencies. Valid components can be categorized in one or more of the following ways: a physically swappable chunk of functionality with a well-defined interface and no dependent state (i.e. if it is replaced it should not take along any state that its replacement would also use); any portion of functionality that is independently configurable, or requires its own operational apparatus, typically including third-party subsystems such as: databases, personalization engine, web and application servers, any unit of execution, information, or structure that appears as atomic from the perspective of someone purchasing, installing, operating or troubleshooting the system. Examples of such components include: the executable itself, shared libraries, configuration files, licensing files, and directories that must exist so log files can be written to them.

Multiple configurations components can be brought together in a common container, producing larger components, which eventually can execute in a runtime container such as a Java virtual machine. There are four basic ways to achieve this incremental assembly. Each of these corresponds to a different point in the delivery cycle in which a different user role is involved in specifying the actual configuration, as follows:

Developers using tools in the development environment such as compilers/linkers;

Delivery personnel who use custom tools to build-to-order for end users;

Deployment personnel who at installation time use custom or standard OS tools to customize configurations for the end-user needs and/or various operational characteristics of their environment; and

End users who select which functionality they desire

The configuration strategy can be defined once if it is common across all configurations, else each alternative strategy should be defined separately.

Application Layer/Process View

This view captures dynamic interactions required to fulfill various use case functionality. Not all interactions need be shown, only representative interactions that may be few in number (or may be none). Examples include sequences involving: complex user interfaces processing, multiple resource coordination, and asynchronous interactions among cooperating processes (shown in UML as active classes and objects overlaid on a deployment diagram). UML interaction diagrams are used for these purposes. For readability, this view may include a View Of Participating Classes (VOPC), (i.e. the subset of the design model classes that are instantiated during any illustrated interaction diagrams).

Evolutionary Considerations—Upper Platform Layer

This layer comprises runtime containers and mechanisms. Mechanisms are supporting capabilities that require a uniform solution across areas of an application, and typically require some level of ongoing operational management. For example, persistence should in general be uniform across objects, even if each object provides a method to make itself persistent. A persistent data store requires various ongoing management tasks, such as backup and restore. It would likely be difficult to manage and scale a system in which every object implemented its own database. Common mechanisms include: persistence, process communication, process control and location mapping, redundancy, shared resource management, external system connectors, transaction management, data exchange adapters, distributed data management, multi-language support, error detection & handling, user authentication & session management, access control, and auditing.

Upper Platform Layer/Incorporated Mechanisms

This section enumerates the required mechanisms in the system. For each mechanism, the tier on which the mechanism is supplied is provided. For mechanisms that cross tiers (typically IPC), the mechanism is listed on the innermost tier. The container that houses the mechanisms, such as a web server or an application server is also supplied, as well as the platform of which the application programming interface (API) or management interface (MI) is part. In one embodiment, the platform is a virtual platform such as J2EE. The API used to access the mechanism, if applicable, is also provided, with the MI, if any, used to access and/or control this mechanism from an operational perspective. Table 4 provides an example description of some of the mechanisms that might be used on a project.

TABLE 4

| Tier | Container | Platform | API | MI | Mechanism |
|---|---|---|---|---|---|
| Presentation | iES Web | J2EE | Servlet | iPlanet | Session |
| | Server | | Container | Management | Management |
| | | Servlet | Console | HTTP Protocol | |
| | | | | | conversion |
| | | iPlanet | | | Load Balancing |
| | | Proprietary | | | |
| Business | iAS App | J2EE | JDBC | | Connection |
| | Server | | | | pooling |
| | | | EJB Session | | Transaction |
| | | | Beans | | Control |
| | | Custom | com.client.txn.a | Logfile | Auditing |
| | | | | inspection | |
| | MQ/Series | J2EE | JMS | | Guaranteed- |
| | | | | | delivery queues |
| Resource | Oracle 8i | J2EE | JDBC/SQL | Oracle | Persistence |
| | | | | Enterprise | |
| | | | | Manager | |
| | iPlanet | | JNDI/LDAP | | Naming |
| | Directory | | | | Services |
| | Server | | | | |

Upper Platform Layer/Custom Mechanisms

If any custom mechanisms are being built for this system, these are described in this layer. The description can make use of any type of UML diagram as appropriate. Most commonly, this will include UML class and interaction diagrams. The interaction diagrams should demonstrate typical and/or unusual non-obvious usage patterns for the specified mechanism. An example custom mechanism is a presentation framework, even if it is layered onto of another framework such as Swing.

Lower Platform Layer

This layer describes supporting infrastructure for an application or set of applications. This includes components at the operating system or below, as well as supporting infrastructure that is largely invisible to the larger application being built. Examples of the latter include: firewalls, LDAP primary/secondary servers, DNS & DHCP servers, routers, subnets, and raid disk arrays. These views are of interest to: system and network architects, system and network administrators, and the hosting provider.

Lower Platform Layer/Configurations View

This view describes various configurations of core processing nodes and supporting devices using UML deployment diagrams. These diagrams will incorporate nodes, communication paths, and other supporting information as required. Any configuration in the application layer configuration view should be consistent with a configuration defined here, while excluding details not of interest at the application layer.

Lower Platform Layer/Evolutionary Considerations—Hardware Layer

This layer may be isomorphic to the lower platform layer, in which case the views can be combined for readability. The mapping may not be isomorphic if advanced features such as domains in Sun E10Ks are used to combine multiple logical processing devices onto one physical device. Whether separate or distinct, the detail at this layer reflects specific hardware choices.

Lower Platform Layer/Evolutionary Considerations—Systemic Qualities

The architecture can also be reviewed from the perspective of individual systemic qualities. These will describe how the architecture has been designed to meet the goals of each systemic quality. This coverage is essential when considering the holistic nature of most systemic qualities, which are only as ‘strong’ as their ‘weakest link’. Security, for example, is easily defeated by holes at just one layer in one tier. As another example, having one component 99.999% available (about 5 minutes of downtime a year) is wasteful if its underlying layer is only 99% available (over 3½ days of downtime a year).

For each systemic quality defined in the requirement specification, there is a separate subheading in the Software Architecture Document. For each systemic quality, this subheading includes a description of: the direct and derived requirements relating to that quality, an explanation of those requirements will have been satisfied, in terms of patterns, technologies, etc.; and implications for future growth, (i.e., how expected growth in the system should be managed). Details will vary for each systemic quality.

The level of detail in these descriptions can vary depending on the degree of formalism desired. On the low end of formality, summary textual descriptions of the goals and their solutions for each systemic quality are addressed (at the end of inception, this includes a summarization of risk areas and how they will be addressed during elaboration). These may also be structured in a matrix format relating quality requirements to their resolution. On the high end of formality, this description includes a summary or more detailed breakdown of the pattern reasoning steps. Collectively these views are of interest to: system and specialty architects, such as security architects, designers, operators, and administrators.

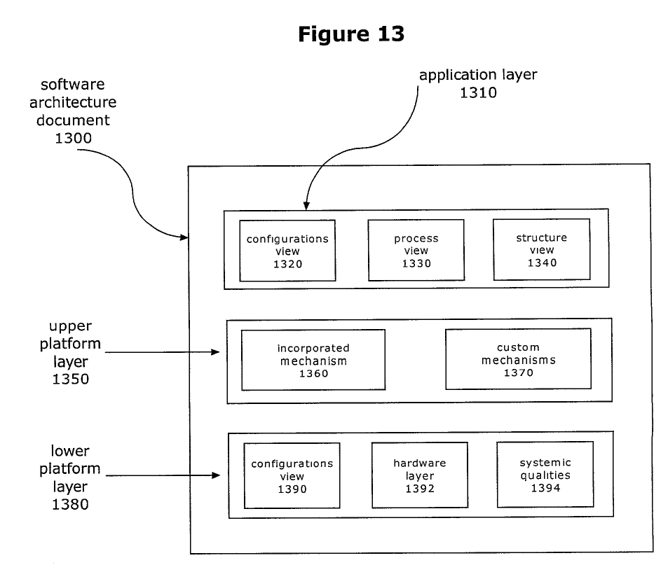

An embodiment of a software architecture document having architectural views is shown in FIG. 13. Software architecture document 1300 includes an application layer 1310 having a configurations view 1320, a process view 1330, and a structure view 1340. Upper platform layer 1350 includes incorporated mechanisms 1360 and custom mechanisms 1370. Lower platform layer 1380 has a configurations view 1390, a hardware layer 1392, and systemic qualities 1394.

Isolation and Impact

One difficulty of examining systemic qualities in isolation is that they often impact one another in various ways. For example, adding redundancy whether for scalability or reliability increases the management burden. Adding depth for processing power increases the number of points of failure and can negatively impact overall reliability. The final set of views not only highlight and clarifies these cross-quality impacts, but also in many ways serves as one of the most useful and informative overall views onto the architecture.

The idea is to separate the consideration of state and intermediate data management from a purely functional view of the system that simply accepts and responds to requests. Subsequently consider state, and then data, and the impacts of each. Describing this in terms of an example should make this clearer. The first perspective is of the system as a functional entity with various control behaviors shown in Table 5. The first row summarizes the sundry control mechanisms at each tier, and each subsequent row describes the strategy for handling the given systemic quality at the given tier. The columns represent the logical tiers of the target system:

TABLE 5

| | Client | Presentation | Business | Resource |
|---|---|---|---|---|
| Control | HTTP, | Screen navigation & | Resource coordination | Legacy system external |
| | Javascript | formatting, rule-based | | |
| | dialogs | personalization engine | | |
| Throughput | | Local Director loan | iES load balanced; | Dun 16-way E10K |
| | | balancing | connection pooling | |
| Scalability | | Add web servers | Add app servers | Sun: E10K expansion |
| | | | | and Geographical parti- |
| | | | | tioning; legacy; limited |
| | | | | expansion |
| Reliability | | Local Director stateful | Web-server redirect | Oracle Transparent |
| | | failover | | Application Failover |
| Availability | | default behavior en- | | |
| | | ables continued opera- | | |
| | | tion if pers. eng. down | | |
| Security | | https for transactions; | https transactions; EFS | Server lockdown, EFS |
| | | Packet-filtering firewall | firewall | firewall |
| Manageability | | Local Director server | | |
| | | connection manage- | | |
| | | ment; SNMP node | | |
| | | control | | |

The cells in Table 5 describe impact (which is often implicit) and response for the given systemic qualities at the given tier. For example, the control activities at the presentation layer include the standard items of screen navigation and formatting of responses, and a rules-based capability for personalization. The load introduced by supporting many users impacts throughout, for which the response is to load balance among multiple web servers, more users can be accommodated by adding web servers.

Beyond the reliability of the web server hardware, no specific measures are taken to make them more reliable. However, the load balancers are themselves made reliable using the vendor-supplied stateful fail over feature. Availability is enhanced by ensuring that the availability of the primary functionality continues even if the personalization engine is down. Security through the presentation tier must pass through the indicated firewall, with encryption for transactions. Finally, management is enhanced by being able to take individual web servers offline (server connection management), and overall by providing SNMP-based control.

In Table 5 state has been ignored. State is defined as direct or indirect accumulated information from the user that is not or has not yet been made persistent in the mainline database. User state is the direct information supplied by the user, such as name and password. System state is internal system information created in response to the user, and which could be recreated provided the same user information is available. A user session is an example of system state. In the next view shown in Table 6, the kind of state that is managed in the system is described.

TABLE 6

| | Client | Presentation | Business | Resource |
|---|---|---|---|---|
| | Navigation | User session, user | Shopping cart | User info & preferences |
| | pos, scroll pos | navigation history | | |
| Throughput | Occasional | Slightly more breadth | Slightly more breadth | Primary/secondary |
| | longer | required to offset | required to offset | LDAP for large user |
| | response times | granularity of loan | granularity of load | base |
| | as server-side | balancing at session level | balancing at session | |
| | query is | | level | |
| | reconstructed | | | |
| Scalability | | | Add app servers | Expand LDAP servers |
| Reliability | | | iP as soft cluster | |
| | | | failover | |
| Availability | | Redirect & restart session | | |
| | | on web server failure | | |
| | | uid/password | | |
| Security | | | Dedicated LDAP | |
| | | | authentication server | |
| Manageability | | SNMP control for user | | |
| | | sessions | | |

The first row in Table 6 describes the kind of state that is managed at each tier. At the client level, the nature of URL links embeds the navigation position in the HTML code displayed in the web browser. In this example, for lengthy scrolling (e.g. as a result of a search) the position in the results list is also embedded in the URLs and no information is kept on the server regarding where the user is in the list (although results data may still be cached in the server). The presentation tier manages the user session that ties together independent HTTP requests and associates them with the identity of the user established during login. The accumulated transaction for this system is in the form of a shopping cart and is maintained at the business tier. Finally, assorted user information and preferences are maintained at the resource tier.

Each cell in Table 6 describes the impact of the state at that tier and the architectural response. For Presentation, for example, maintaining a user session requires all of a given user's traffic to be routed back to the same web server. This effectively reduces the opportunity for load balancing to login time, potentially leading to skewed load balancing scenarios. The throughput response is simply to add slightly more web servers. Scalability is not impacted beyond what has already been discussed in Table 5. Availability is improved by redirecting the user to another web server where although they will have to login again, it is better than completely shutting them out. Security of the user session is governed by user supplied id and password. Manageability is maintained by enabling control over user sessions through SNMP.

In Table 5 data has been ignored, regarding it only in the abstract. In the final view shown in Table 7, the stricture of data is considered at each tier and the impact on systemic qualities. In this context, ‘data’ refers to the data managed by the system as originally defined in the DOM.

TABLE 7

| | Client | Presentation | Business | Resource |
|---|---|---|---|---|
| | HTML | Static content in HTML; | Catalog in cached CML; | Customer Oracle; |
| | | dynamic content in XMK & | Customer in Java Objects; | catalog DB2; billing |
| | | base Java structures | JMS/MQ lazy finish for | fulfillment CICS |
| | | | Billing & fulfillment | |
| Throughput | HTTP | Dedicated static content | Read-only XML caches | Geographically |
| | conditional | server; dedicated personal- | do not need | partition Customer |
| | Gets | ization server; external | synchronization | |
| | | image server farm | | |
| Scalability | | Add content, pers, Servers | No limits to adding | Smaller geographic |
| | | | servers | partition |
| Reliability | | Redundant local balances & | Redundant app servers | Raid mirroring, |
| | | web servers | | Oracle Parallel |
| | | | | Server; independent |
| | | | | geographical |
| | | | | partitions |
| Availability | | Primary use causes still | Node downtime has no | Non-transactional use |
| | | function if presentation tier | effect on other nodes | ‘causes still function |
| | | data is unavailable | | if customer DB is |
| | | | | down |
| Security | SSL | SSL; No restricted data | EJB ACLs, instance- | SQL Roles |
| | | | based checking | |
| Manageability | | SNMP | SNMP option to flush | Vendor |
| | | | caches | administration tools |

Unlike state, data is necessarily present at each tier. However, it usually takes on a different structure even though it is all a representation of the DOM. The first row in Table 7 describes the manner in which data is represented at each tier. Data might be, for instance, HTML at the client tier, which is created in the presentation tier from a mixture of XML, base Java objects (i.e., objects containing only base data types), and some pre-fabricated HTML for static content. At the business tier, a rich Java object model is maintained, along with XML for catalog data that is also cached at this tier. Update transactions are dumped off to a persistent queue that is another kind of data representation at this tier. Ultimately, the data is made persistent at the resource tier in the variety of formats specified. Consistent the preceding views, the cells in Table 7 represent the impact and response of the data management at that tier for each systemic quality.

Process

Architecture development is largely a matter of applying pattern based reasoning. What varies is the amount of formalism applied, and the precision that is dedicated to describing the outcome. Bearing in mind that process serves purpose, the invention does not mandate elaborate efforts in architecture. Rather it attempts to provide a rich set of guidelines and principles to draw on when perceived as beneficial. This may include selective uses of these techniques, and in all cases it precisely means to use only that which moves one closer to the end result than one would have been otherwise.

At a minimum, the invention requires the subheadings in the Software architecture document be addressed at a level of detail that generates confidence in the result, with a focus on risk identification in inception and risk resolution during elaboration. Beyond that, the invention describes in detail the process of applying patterns, in conjunction with a rich catalog of patterns. This section provides additional detail on this process.

Given the number of patterns, pattern based reasoning alone can be difficult to work through without a sense of priority for deciding where to start and how to proceed. Table 3 outlined subsumption priorities for structural principles, which are a starting point. Patterns that affect higher-priority structure, as defined in Table 3, should be considered before those that affect lower-priority structure. However, much of that grouping relates to the Application and Upper Platform Layers. Systemic qualities also need to be considered across all layers. A similar kind of ordering among systemic qualities is described in Table 8, which also roughly summarizes the impact of each quality on each system layer.

TABLE 8

| | | Application | Upper Platform | Lower Platform | Hardware |
|---|---|---|---|---|---|
| 1 | Scalability/ | Move/transform | Mechanisms for | Resource | Horsepower, esp. |
| | Throughput | data, cache, | breadth | optimization | I/O |
| | | prefetch, etc | | | |
| | Performance | Optimize multiple | Internal design | Resource | Horsepower |
| | | hops | | optimization | |
| | Security | Declarative control | ACLs, encryption, | System control | Firewalls, physical |
| | | e.g. through ACLs | sessions, etc. | | topology |
| 2 | Availability | Error-handling | | | |
| | | strategies | | | |
| | Reliability | Code quality, error | Redundancy & failover | Redundancy & | Quality |
| | | recovery | | failover | components, |
| | | | | | Redundancy & |
| | | | | | failover |
| 3 | Maintainability | Structure | Encapsulation of | | |
| | | | mechanisms | | |
| | Manageability | Hooks | Hooks & tools | Hooks & tools | Hooks |
| 4 | Flexibility | Structure | Abstraction model | Low-level | Low-level |
| | | | | computational | computational |
| | | | | model | model |
| | Reusabiity | Structure | Abstraction model | By definition | By definition |
| | Serviceability | Configuration | Configuration | Modular design, | Modular, accessible |
| | | management | management, patches, | patches | components |
| | | | design | | |
| 5 | Usability | Design | High-level, flexible | | |
| | | | Mechanisms | | |
| | Accessibility | Design | Mechanisms | | |
| 6 | Buildability | Structure maps to | | | |
| | | team | | | |
| | Budgetability | Buyable parts | Affordable | Timely | Affordable |
| | Planability | Structure at | Timely development of | development of | Timely |
| | | appropriate | expertise | expertise | development of |
| | granularity | | | expertise | |

Six prioritorized groupings are defined in Table 8. Scalability, throughput, and performance are all part of the first group since they strongly affect all the layers, and because other systemic qualities will be built around the structure composed to solve these problems. Scalability and throughput are furthermore grouped in the same row since throughput can be considered as a near-term target for eventual scalability. More scalability often results in more points to secure, and security mechanisms can directly impact performance and throughput, so security is included in the first category as well.

The second group in Table 8 is availability and reliability. Beyond the selection of quality components (things that do not break), reliability is largely a matter of redundancy. The structure of redundancy usually follows the structure incorporated for scalability and throughput, and for this reason reliability is placed below those qualities in the ordering. Availability is likewise heavily intertwined with reliability, insofar as lower reliability calls for greater emphasis on availability and vice versa.

The third group comprises maintainability and manageability. Manageability follows the previous qualities because it is defined in response to the structure incorporating those other qualities. Similarly for maintainability, which must be designed to fit around this pre-defined structure.

Flexibility and reusability are in the fourth group, as a way of saying that if a system is designed well enough to be easily maintained, then this structure will go much of the way toward providing flexibility and reusability. Serviceability has similar attributes, mostly at lower layers. Usability and accessibility constitute the fifth group since architecturally their scope is not so much structural in nature but design guidelines for a particular subset of design elements. The developmental qualities fill out the last group. Similar to the reasoning in Table 3, most of the issues arising from this category will have been solved based on earlier efforts.

Whereas Table 3 describes the result, and Table 8 describes “issues to consider”. The recommended ordering principle incorporating both of these tables is as follows:

1. For each group in Table 3

2. Apply each of the groups in Table 8—excluding qualities that overlap with those which are essentially covered in Table 3, for example the entire group 6, as well as maintainability, flexibility, and reusability. In addition, group 5 only applies in certain cases.

3. Identify relevant unknowns, uncertainties, and problems meeting these criteria

4. Work through the pattern-based reasoning process as outline in the previous section.

Between steps 1 and 2, this leads to the following initial steps:

1. Define a layering and distribution structure accommodating scalability and security;

2. Define where high reliability is needed and how this will be accomplished; define availability strategies where required;

3. Define the overall management strategy, define what needs to be managed and how;

4. Define what needs service, which is largely a matter of considering whether the system can be brought down to replace, upgrade, or otherwise service a component

5. Now consider the structuring principles from the second group in Table 3,

which includes generality, exposure, and functionality. Consider the scalabihty/throughput/performance and security impacts for each of these. For example, at the exposure level the structure, quantity, and caching/prefetching issues all impact scalability, throughput, and performance, and for security reasons a facade style pattern maybe incorporated to limit what is exposed.

6. Consider if any of the resulting structure has any unique reliability or availability issues.

7. Consider if any of the resulting structure needs to be managed independently

These steps are only high-level outlines. Some will require a lot of work (especially earlier ones), others less so. Most will have to be revisited over the course of the project perhaps multiple times, largely depending on the amount of risks involved. At a minimum, this will occur once for inception (high level, find risks, define scope) and once for elaboration (thorough, resolve risk, validate scope). Across layers, much of the work may also proceed in parallel. For example, steps 2, 3, and 4 can be performed by one group with expertise distinct from another group that can begin step 5, and so on. This parallelization across layers is important, insofar as the skill distinctions are most pronounced across system layers.

In the larger picture, certain early steps can be applied based on well-defined rules, drawing heavily from experience. Various preparation steps and various finalization steps can also be applied. Three recurring steps apply across all categories:

1. Analyze to determine what problem(s) remain to be solved.

2. Applying structuring principles to address those problems.

3. Adjusting the architectural decomposition as a result.

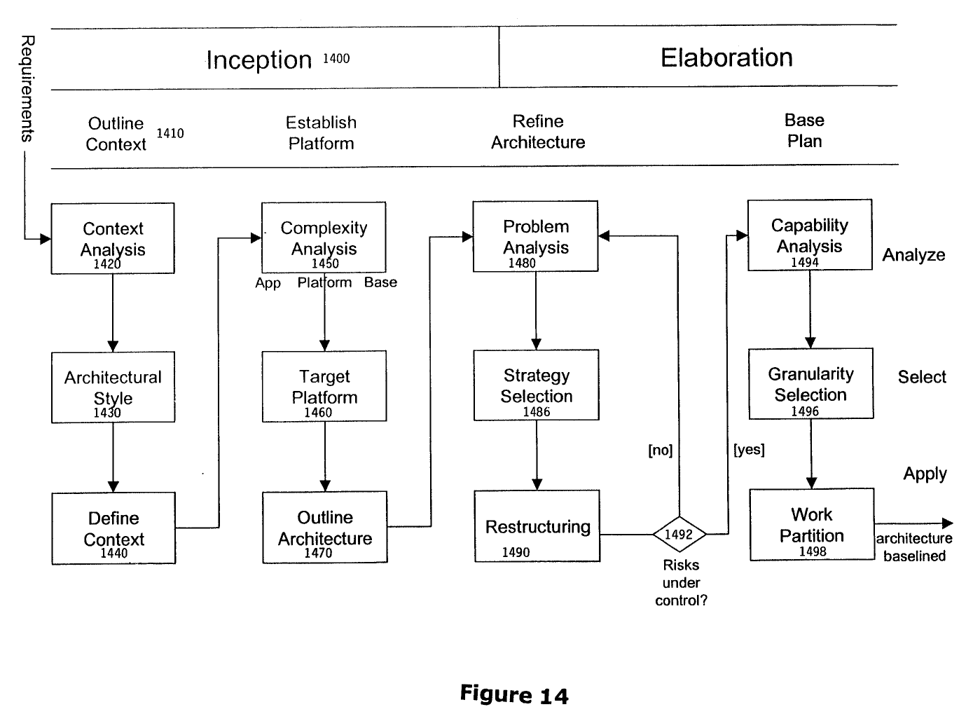

These three steps are applied repeatedly, across sub activities, until the desired granularity of structures has been achieved. This is illustrated in FIG. 14.

Outline Context (Inception)

The system context comprises the set of actors, or external entities of our system, along with any environmental constraints that apply. Actors are by definition outside of our control so accommodating their behavior represents constraints on our own system, much like a more detailed form of requirements. During the Inception phase 1400, a phase of outlining context 1410 occurs.

Context Analysis

Context analysis at block 1420 is a complexity analysis of actors (in later steps the complexity of the system will be assessed). Considerations applicable to human actors might include: What is implied by particular skill sets or lack thereof? Might training or specialized job functions still be considered an option? What are the channels by which they will access this system? Web browser, cell phone, set-top box, etc? What is the style of their interaction, GUI, FUI, VLTI? What forms of media should be included, e.g. video, real-time chat, etc.? Can any particular complex mechanisms be identified, such as support for real-time feeds? Change notification, Shared white-boarding, Multi-level undo, Features for advanced users, such as type ahead, Offline operation, Does the nature of their work constrain the interaction style, e.g. requiring several screens to be visible at once?, Can an estimate of the quantity of screens be made at this time? Will they use this system within the bounds of a controlled network, at a partner site, over the Internet, etc.? How many actual users of this type are expected, and what are their typical and peak usage patterns? and Will the nature of their usage of the system require access control at the operation or instance levee.

Considerations for system actors might include: What protocols must be supported, What is their complexity, from a behavior or data perspective?, What is the completeness and accessibility of documentation, and/or availability of expertise in these protocols?, Do they have well defined systemic qualities? If not then we assume their risk., Where are they located? What level of control do we have over these systems? Are there any possibilities for modification if required?, How can we develop and run test suites against them?, For updates, do they have test data stores, or can we back out updates?, What development and test activities may interrupt their normal operation?, and Is the interaction synchronous (requestor waits for response) or asynchronous (requestor does not wait for response)?

Architectural Style

Drawing on information established in block 1420, the overall system is characterized based on certain high-level principles at block 1430. These include, for instance: Will the system manage internal state? In this context, state refers to any information that is held by the system across interactions. General variations include: Centralized responsibility for managing state, even if various processing tasks are handed off to intermediate nodes, Distributed responsibility for managing state, in which autonomous peers interact in some way, No management of state, also called stateless, in which the system only exists to provide certain transformational services How tightly coupled will be the primary communication paths? One of: tight, synchronous exchange, Loose, asynchronous exchange (which could further classified as guaranteed vs. unguaranteed exchanges), Undirected, asynchronous exchange in which the zero or more recipients are not known to the sender, How precise will the direct interaction be on these paths? One of: Control, precise well-defined message invocations with small amounts of data in each, Data, in which messages involves larger streams of data flowing over relatively fewer message types.

These decision points are approximations. Some represent a continuum rather than simple scalar values. Moreover, these characterize the high-level ‘macro’ aspects of a system; they do not preclude incorporation of contradictory techniques at lower levels of system design that may evolve later in the process.

Possible descriptions for some well-known architectural styles include: pipes & filters: stateless, loose or undirected, data, blackboard: usually stateless, undirected, data, Autonomous agent: distributed, loose, data, alarm system: distributed, loose, control, XML web-based services: distributed, undirected, data, network element management: central, loose, control web-based order entry: central, tight or loose, control.

These considerations form part of the basis for defining the architectural style of the target application. What remains is to describe the major piece-parts between which communication will take place. For reasons explained later on, the first step in any architectural definition involves consideration of scalability and security, and should already have been identified information about these requirements in the context analysis block at 1440. For typical Internet applications, scalability and security can be significant challenges.

Common solutions to these problems are: formulated as architectural patterns. The most common solution to both these problems involves an isomorphic structure commonly called tiers. A tier is defined by its distinctiveness as compared with other tiers in its enclosing multi tier system. A ‘tier’ can be defined specifically at three levels. A conceptual tier represents a cohesive aggregate layer supporting some distinct level of internal functionality. Conceptual tiers represent a kind of horizontal layering (distinct from layering by abstraction which is typically drawn vertically) of the system by this principle.

Example conceptual tiers include: client representing the point at which model data is consumed externally, presentation mediating between multiple diverse clients and the middle tier and to distribute statically or dynamically generated code to clients outside the control of the immediate system, business logic or business services, or sometimes just middle providing an integrated view of core business services, integration wrapping access to diverse resources in the backend tier, database or the more general resource or backend where data and other resources including other internal (often legacy) systems are managed.

There is no universal conceptual tier structure, but most uses are minor variations of a common set of themes. This includes a client and/or presentation on one end, database and possibly integration on the other, and the middle tier mediating all interactions between them. The arrangement is not necessarily totally ordered, since for example some clients may need to go through the presentation tier and some may not. However, everything passes through the middle tier that acts to maintain the integrity of the underlying business processes.

A logical tier is a segmentation of the collective software units of a system such that communication among elements on different logical tiers is capable of taking place over a network. For simplicity of design, logical tiers usually map closely or even exactly to conceptual tiers. However, this correspondence may deteriorate as various design issues are considered over time. For example, portions of business logic may be made to run on the presentation and/or client tiers, or inside the database for performance reasons.

A physical tier consists of one or more computing devices that share common scalability strategies, security requirements, or control (with respect to the system being defined) characteristics. A physical tier may be defined by one of these characteristics or all three. Physical tiers may match one-to-one with logical tiers. Alternatively, the system may be designed so that multiple logical tiers run on the same physical tier. This is done to allow for multiple configurations or for future evolution of the underlying hardware topology without requiring significant code change.

Devices within a physical tier share common characteristics with respect to one or more of these questions: Is control over the device maintained? For example, on the Internet by definition clients are outside control of any application; What is the scalability strategy for devices in this tier? For example, the middle tier often applies replicated load balanced servers for scalability; Must the device be separated from others by additional security? For example, a distinction between two tiers may be due to the need to place a firewall between them.

Each tier is also characterized as homogeneous or heterogeneous. The presentation tier, for example, is homogenously comprised of an expandable number of similarly configured web servers. The resource tier is more often heterogeneous. For example, a given resource tier may consist of 2 identically-configured Solaris 4500s running Oracle, an IBM MVS/CICS mainframe system managed by another department, and a payment server accessed over the Internet using XML.

Now derived requirements may be defined. Derived requirements are a refinement of system quality requirements, taking into account the overall technical context as well as the selected architectural style. Derived requirements include considerations such as: how external requirements impact internal systems, (e.g., what does supporting 1000 simultaneous requests mean for the order entry system?); making more specific interpretations of vague quality requirements, such as redefining ‘a significant increase in users are expected’ to ‘the number of users is expected to double in 1 year’; what protocols must ‘be supported to comply with the intent of ‘open industry standards’?; what are the likely areas of future evolution for a ‘flexible’ system?

The context can be documented with a context diagram that illustrates the relationship of each external system and primary human actor to the system. An informal description of these relationships can expand on the nature of the interconnection and the derived requirements.

Establish Platform (Inception)

Platform selection and exploitation is a fundamental and early part of any modem development effort. Many subsequent decisions will depend on it, including the very fundamental question of buy vs. build; most commercially available components have dependencies on the selection of platform

Complexity Analysis

Now, an early assessment of the complexity of the system is made, layer by layer at least for the major layers. This will be used to understand the need for various components to handle the unique and complex characteristics of the target application, and ultimately to understand its scope. Application layer analysis at block 1450 begins with a review of the use case list and domain object model. The DOM may or may not have been detailed by this time. Sufficient modeling is done to get a feel for the overall complexity required of the functions that will operate against it. The architect: is concerned less with the surface issues and more with the indirect ramifications of various functions. Table 9 lists some examples.

TABLE 9

| Architecture is concerned less with | . . . and more with |
|---|---|
| What happens when a button is pushed. | How often the button is pushed, how many users |
| | are simultaneously pushing the button, where the |
| | users physically are (e.g. inside the intranet, out |
| | on the Internet, etc.) when they push the button. |
| How the system should respond to an event. | The timing constraints if any between events. |
| Which bits of information should be | What kinds of constraints should be placed on |
| supplied in response to an event | which kind of data, based on which user |
| | characteristics. |
| What are the business rules. | How complex are the rules? How often are they |
| | changed, and which areas are likely to change? |
| | Can they be changed by programmers or by |
| | users themselves? |
| What is the domain model. | How complex is the model, what are its |
| | persistence characteristics, e.g. granularity, |
| | frequency of updates, what is its expected size, |
| | do external systems incorporate their own |
| | model? |

These should be considered against the need for representing the domain model at each tier. The OrderEntry table in an RDBMS, the OrderEntry object in the middle tier, and the OrderEntry data structure used to shuttle information to the client tier are all representatives of what was one conceptual entity in the domain object model. N-tier systems have N representations of the domain object model, and N 1 tier pairs along which data must flow. At this point in the process, choose the basic representation of the model for each tier. This tier/domain map should be shown in the logical view of the architecture. Along each path between tiers, consider how often data flows and at what granularity, and if the mapping is uniform in both directions.

All the preceding considerations lead collectively to the identification of required mechanisms to support application functionality. Based on the use cases, DOM, and tier representation need for the following mechanisms (among others) might be identified: persistence, external connectivity, transactions, data mapping & transformation, multi-language support, error handling & logging, authentication & session management, and access control and auditing,

This list is augmented with platform layer analysis, which also occurs at block 1450. Whereas application layer analysis considered mostly application functionality, platform layer analysis considers the nonfunctional requirements for the system as well as the tier structure and communication mechanisms already established. The mechanism list might be extended to include: inter-process communication, process control, process location & binding, redundancy shared resource management, distributed data management, error propagation, encryption, validation, and authorization. Finally, base layer analysis at block 1450 examines the lower platform layers. This includes an early initial assessment of the required hardware environment and whether additional hardware investment may be needed to support the proposed systems.

Target Platform

Targeting the platform at block 1460 involves choosing the overall platform and its key components. The suitability of industry standard platforms such as J2EE is well documented. Of interest is that the timing of the decision is made before most platform components are selected and the outline of the architecture is constructed, which in turn bears heavily on the upcoming risk assessment. The selection of development language(s), if at issue, should also be made in this timeframe.

Platform components are introduced to provide the implementation of identified mechanisms and to support systemic qualities. An early catalog of components is made even though it is likely to grow or change through the end of elaboration. Examples include the use of OO-relational mapping tools to handle the domain mapping between the middle and backend tiers, the use of Enterprise Java Beans for transactions, an application server for load balancing or soft clustering, etc. Drawing on experience as well as consideration of what technologies are existing and available, it is appropriate that many of these decisions may reflect specific technology choices even at this early stage of design.

Even with a strong preference towards buy vs. build, there may be some need to provide custom platform components. These are probably thin layers, such as higher-level IPC mechanisms, layered on other commercially available components. Identifying the need for these now will ensure they considered in any subsequent planning process. By a similar line of reasoning, any custom platform (or application for that matter) components which are intended to be reusable should be identified at this time since that will significantly increase their cost.

Outline Architecture

An important consideration in platform selection is how close it comes to providing the required mechanisms. However, the match may not be exact, or it may not be clear how close it might be. In block 1470, what portions of the selected platform to be used are identified, and what pieces may be missing or unknown are also identified.

At least one configuration is described. Depending on where the main layer focus of the project is, the selected configuration may be the application or the lower platform or hardware configuration. However, since this is inception, this need not reflect extensive detail.

Refine Architecture (Inception/Elaboration)

Typically, to refine the architecture, the following is dealt with: the demands of managing large numbers of transactions, data management operations, and user sessions exceeding the capabilities of any single box; multiple boxes leading to a manageability problem; connecting to the Internet giving rise to the possibility that anyone can access sensitive data; downtime leading to significant business loss; and the relatively large and diverse amount of code development, as well as the skills shortage of senior experienced people, requires multiple builders.

The demands for systemic quality lead to risk. A risk is the possibility of loss. What might be lost is the achievement of the business goals as defined through systemic qualities. An uncertainty is an identifiable state of affairs that might exist in the future. An uncertainty is defined by a probability and impact, where the impact is a direct function of the systemic quality(s) affected. For example, if the risk is that a given throughput target might not be reached, and that throughput target is flagged as critical, then that risk's impact is critical.

An unknown is a risk whose probability is unknown and whose impact is unknown because the outcome is unknown. An unknown exists when no plan has been defined for a systemic quality. Uncertainties always have a probability of occurrence that is greater than zero but less than one. A probability of exactly one is not an ‘uncertainty’ but a ‘certainty’ which is more directly referred to as a problem. The difference is that uncertainties may be addressed by various mitigation strategies, whereas problems must be solved directly. The resolution of unknowns, uncertainties, or problems is reflected as part of the solution.

The level of problems and solutions that are accumulated vary significantly. For example, one valid solution to scalability might be ‘replicate horizontally’. This says little about how this replication would occur or what are the specific components that will be replicated. A more specific solution might be along the lines of ‘incorporate the self load-balancing clusters from vendor x’. Although problems and solutions are described more abstractly earlier in the process, and more concretely later in the process, the evolution is rarely so orderly. Often concrete decisions are made early (especially under time pressure, for better or worse). And/or, sometimes abstract problems result from concrete solutions even late in the process (‘now that we have incorporated load-balancing clusters from vendor x, there are problems of chattiness resulting from the frequent replication of state used in its failover mechanism). To describe problem resolution at different levels of abstraction, abstract problems and solutions are distinguished from concrete problems and solutions.

Problem Analysis

Problem analysis is the determination that problems (including, in this usage, unknowns and uncertainties) exist. Problem analysis takes place at block 1480 of FIG. 14. The goal of problem analysis is to identify the problems with the greatest specificity possible. As the refining of the architecture process is started there are several sources for this information: Risk Analysis involves finding risks, in this case technical risks. Technical risks can be identified by examining the system context, non-functional requirements, and the required mechanisms (from Complexity Analysis) and component decisions.

Examples in general might include: the system requirements, especially the systemic quality requirements; the output from incremental reinforcement from the requirements workflow; the system context as explored in context analysis; required mechanisms as determined during complexity analysis; other complexity as determined from outline; and any identified and perhaps quantified problems with an existing design or system.

Hands-on experience through prototyping enhances the knowledge of the architect(s), who then can better characterize problems. Testing of the prototype may identify inability to satisfy requirements; for example load testing may reveal inabilities to handle user loads for certain types of requests, and stress testing may reveal non-robust behavior under extreme loads. Solutions which themselves introduce new problems, which hopefully are smaller and/or more manageable than the original problem(s) solved; and changes in or refinements of the original requirements.

Strategy Selection

Strategy selection takes place at block 1486 and involves selecting one or more problems to solve, and selecting a strategy to move past those problems. Conversely, it can be described as selecting a solution that can solve as many problems as possible. Example strategies include: architectural pattern describing the general approach to a problem (abstract solution); architectural design pattern describing the approach to solving the problem incorporating specific platform mechanisms; new component that must be synthesized to solve the problem; available component that can be linked into the application; 3^{rd}-party product; mitigation strategy.

An architecture pattern models an architectural problem and a solution in the abstract. As compared with classical design patterns, architecture patters are characterized by the macro elements of architecture such as subsystem. A design pattern can be completely characterized by an instantiation of well defined seat of classes. An architecture pattern, on the other hand, is typically characterized by principles of abstract relationships among elements that have less of a fixed structure. Sometimes the distinction involves a subtle shift. The GoF Proxy design pattern [Design Patterns, Gamma et.al, Addison-Wesley 1994], for example, takes on an architectural form when describing its instantiation not just in a singular sense but generically across two subsystems.

An architectural design pattern has elements of both. It also differs from both in that it describes solutions always in a particular solution language. A solution language is not a computer software language but is instead a family of related design components. Example solution languages include: a platform such as J2EE; a technology; or a particular vendor's framework.

An architectural design pattern can be a refinement of an architectural pattern in the context of its solution language. Or it might exist only to address a problem area very specific to its solution language that could not be characterized as a refinement of an architectural pattern. In the latter sense, it is more like a design pattern. In either case, it always describes its solution in terms of its solution language.

Each pattern definition follows a particular structure, although there is some amount of pattern structure variation in the patterns community overall. The architectural patterns are formatted to make them more easily recognizable for their architectural purpose. It involves roughly the following steps:

Identify patterns with a context and scope which matches your own;

Within that set, look for targeted problem statements which match your own;

Verify that the identified forces reflect your problem in detail;

After looking at the solution consider the pattern's rationale which describes how the forces were resolved by the solution; and

Double-check the pattern's known uses section to ensure that another pattern might not be more appropriate.

The use of a pattern to solve a Problem may introduce new problems that need to be solved, and/or it may introduce new opportunities to solve other problems. For example, load balancing is a problem that exists only after we choose to apply a pattern for replicating servers. To capture this evolving context, each pattern has a resulting context section. In effect, a pattern expands, diminishes, and/or changes the problem analyses for subsequent steps. The resulting context serves to match up with the starting contexts of other patterns that may be applicable for solving the new set of problems. In this way, the patterns are designed to reinforce one another. A family of patterns arranged in this way is called a pattern language.

An additional strategy for problem solving is a mitigation strategy. A mitigation strategy is particular to the class of problems we are identifying as unknowns and especially uncertainties. The following are examples of mitigation strategies: contingency planning allowing for backup plans to be initiated should the risk come to pass; avoid the risk entirely by putting in place an alternate plan; mitigate by lowering the probability and/or severity; transferring the risk to someone outside the current project; accept and live with the risk.

Restructuring

The application of each strategy results in greater refinement. This refinement is reflected in the evolving set of views. Structural decomposition is reflected in the Application Layer structure view. If the process structure has become complex, then a Application Layer process view may be warranted. Mechanism usage is reflected in the Upper Platform views. Configuration variations can be captured at different layers. Even if not captured formally in views, structural and configuration changes are also reflected in the underlying directory structures and physical organization of the system.

The systemic qualities isolation sand impact views are an important place to capture restructuring at a summary level. This takes place at block 1490. These views are tables that describe the systemic quality impact of the system excluding and then considering state and then data. At the start of this process, the simplifying approach of considering systemic qualities in isolation was taken. In practice, there are varieties of ways in which decisions impact one another, even if those decisions initially seemed to address completely independent problems. The isolation views of the server to cross check these decisions in the larger context.

Architectural Refinement Example

As a simplified example, consider reasoning through 1 unknown in 4 steps, as illustrated in Table 9:

TABLE 9

| | | (a) Optimize for low cost | | | | | |
|---|---|---|---|---|---|---|---|
| | Constraints | | | Abstract | Abstract | Concrete | Concrete |
| | Patterns/tools | Unknowns | Uncertainties | Problems | Solutions | Problems | Solutions |
| S | (Requirement) | 1K users | | | | | |
| 1 | Replicate | | | Distribute | Breadth | | |
| | Servers | | | requests | | | |
| 2 | Loan Balancing | | Router is | Choose | Breadth | | |
| | Router | | bottleneck | router, | router | | |
| | | | | Choose | | | |
| | | | | routing | | | |
| | | | | algorithm | | | |
| 3 | Select software | | SW Router is | | Breadth | Choose SW | SW router |
| | loan balancing | | bottleneck | | router | routing | |
| | on low-end box | | (prob-50%, | | | algorithm | |
| | | | impact-severe- | | | | |
| | | | no 1K) | | | | |
| 4 | Mitigate by | | HW Router is | | Breadth, | Low cost | HW router |
| | choosing HW | | bottleneck | | router | violated | |
| | router | | (prob-5%, | | | | |
| | | | impact-same) | | | | |

Table 9 starts by identifying all relevant constraints to the problem being solved. Clearly an entire system can have a substantial number of constraints and other concerns to be considered at any given time, but for practical reasons the reasoning process is isolated into manageable chunks. In Table 9, the problem is how to support 1000 users, and the single (in this case) constraint is to optimize for low cost.

After the starting requirement (step ‘S’), the replicate series architectural pattern is chosen at step 1. The description of this pattern has a resulting context in which the problem of distributing the requests among the replicated servers should be solved. At step 2 the architectural pattern load balancing router is applied in which all requests are routed through a single point which makes the balancing decisions. This pattern introduces the uncertainty that the router itself may become a bottleneck. The algorithm used by the router must also be chosen.

At step 3 a specific vendor's software-based router is chosen, since it is the cheapest available and low cost is a constraint. Still it is only 50% certain that the software router will be fast enough, so this is a risk and its severity and impact is recorded.

To be thorough, a mitigation plan is considered: replace it with a hardware router. This is more expensive but has a low probability of being a bottleneck. Step 5 in Table 9 is in italics to indicate that it is a mitigation step and need only be considered if the existing risks become actual problems. Later in the project, quantified analysis is substituted for a priori reasoning. In this example, the eventual results of the load test will either result in the uncertainty being removed from step 3, or will result in step 3 being removed altogether in favor of step 4 (the mitigation plan).

In practice, actual architectural development involves many of these kinds of methodological reasoning steps, often involving many more constraints and unknowns and uncertainties simultaneously. Understanding this reasoning process may help, particularly for more complex problems in which it is difficult to keep track of all relevant considerations. On a more formal level, these tables can be used in the Software Architecture Document to describe the manner in which systemic qualities have been satisfied. With reference again to FIG. 14, it is determined at block 1492 whether the risks are under control If not, block 1480 repeats, otherwise, capability analysis takes place at block 1494.

Capability Analysis

Often, the team composition changes between elaboration and construction. Specialized and/or less senior resources are usually added in construction, perhaps in large numbers. The core of the smaller more senior team should still be participating, although roles may change to less ‘hands-on’and more oversight, review, and management. An assessment should be made of this team composition relative to the level of difficult and granularity of the current architecture.

The following kinds of questions should be considered: Does the packaging granularity match the team size? Are all skill sets accounted for? Do the required skill sets imply a grouping into teams that can be mapped to the existing package structure at some level? Will different skill sets be available at different times, and does the package structure facilitate areas of responsibility that match the timing of the availability of these skill sets? Is the team geographically located? Does the architecture lend itself to this geographical split? Are there specific security requirements for certain areas of the architecture, and does this match to available security clearances?

Granularity Selection

The questions above may identify the need for further structural decomposition at which point granularity selection takes place at block 1496. This is done late in the process in hopes that the existing architecture already handles most if not all of these cases. If more breakdown is still needed, it is recommended that certain decomposition heuristics be reconsidered so that the result still is not arbitrary. In particular, these decomposition heuristics should be considered: Functionality, Exposure, Coupling & cohesion,

Work Partitioning

The final step at block 1498 is the preparation of the project and iteration plans. The project plan includes the major milestones terminating phases, and the minor milestones terminating iterations. All use cases should be assigned to an iteration in the project plan. The iteration plan includes a detailed Work Breakdown Structure (WBS) and team assignments for the next iteration.

Realization Workflow

The realization workflow transforms well-defined units into working and tested code.

This involves all of the following activities treated as a singular responsibility for each subsystem: Its internal design, optionally using models even if they are transient and discarded after use (the approach should follow the guidelines set forth by the architect), Its implementation in an executable language such as Java, Integration tests which demonstrate that it conforms to its purpose, and optionally unit tests for selected complex internal classes

Validation Workflow

The UML defines a kind of relationship called realization, which specifies a relationship between two things whereby one adheres to the contract specified by the other, typically higher-level (i.e., incorporating fewer implementation details) thing. Whereas realization is the subject of the realization workflow, the validation workflow exists to verify the correctness of realizations relaxed to requirements and across the macro elements of the architecture. Lower-level validation is incorporated directly as part of the realization workflow.

There are various kinds of testing: System testing demonstrates how well the black box system conforms to its requirements, Systemic quality testing is a kind of testing which focuses on systemic qualities rather than functionality, Acceptance is the final system test demonstrating that the entire system has satisfied the criteria for completeness, Integration or subsystem testing demonstrates the conformance of subsystems to their specifications, often relying on internal knowledge of that subsystem to test for boundary conditions, Unit testing at the class level for demonstrating that the class implementation adheres to its interface (used here generically, whether or not a particular programming interface construct is used)

A test's definition is distinguished from its implementation, and note that each should be reviewed by another stakeholder. These two dimensions lead to four roles: The Test Definer defines the test goals, scope, and approach; The Test Critic reviews the work of the Definer; The Test Executor implements the tests; and The Test Reviewer reviews the results of the tests.

Table 10 illustrates typical responsibilities for the categories of tested listed above:

TABLE 10

| Workflow | Test Type | Definer | Critic | Executor | Reviewer |
|---|---|---|---|---|---|
| Validation | Acceptance | Business | Client sign-off | Tester | Analyst/sign-off |
| | | Analyst | authority | | authority |
| | Functionality | Tester | Approach: | Tester | Business |
| | | | Architect, | | Analyst |
| | | | Content: | | |
| | | | Business | | |
| | | | Analyst | | |
| | Systemic | Architect | Tester | Tester | Architect |
| | Quality | | | | |
| Realization | Integration | Architect | Developer | Developer | Architect |
| | Unit | Developer | Peer | Developer | Developer |

Functionality, integration, and unit tests are performed each iteration, and incorporated into a regression test suite. Regression tests are also run for each iteration to ensure that breakage resulting from the addition of new functionality is caught as early as possible.

Project Management Workflow

The project management workflow covers: Making estimates, Constructing plans, and Tracking projects to plan. The present invention encourages the use of separate project and iteration plans. These correspond to macro and micro plans, respectively. Each project will have one project plan whose primary purpose is to: Define the targeted dates and resource requirements of each macro (phase) and micro (iteration) milestone, Describe the targeted functionality of each iteration, described as some combination of: complete or portions of use cases, quantifiable demonstrations of achieving systemic qualities (e.g. demonstrating 500 simultaneous virtual users performing an activity), levels of rework (as the project progresses)

A project plan is a set of top down estimates. It is not uncommon to reflect business-driven ‘wish’ dates in the project plan. It is reasonable for a business to define target dates to meet certain business goals. On the other hand, it is not productive to pretend that such dates are ‘solid’. This results in missed dates, quiet distrust and demoralization among the troops, and much frustration all around.

Each iteration (except possibly the inception iteration) has its own detail plan separate from the project plan, in the form of an iteration plan. This incorporates a standard Work Breakdown Structure WBS) describing tasks, their durations and dependencies, and their assigned workers. A detailed guide to daily activities, the granularity of task breakdown may extend to weeks or even portions of weeks. The level of formality depends on project size and structure. Larger and more complex projects clearly need more controlled planning. Timing is also a consideration. There may be less need for formality prior to Construction since the group is smaller, more senior, and the nature of the tasks is more exploratory (a situation which in some circumstances for some project managers may lead them to the opposite conclusion).

As a given iteration proceeds, the project manager is responsible for piecing together the plan for the subsequent iteration, so that no planning delay need accompany the transition between iterations. As a bottom-up plan, the iteration plan should be synthesized from raw input provided by those who will be most directly responsible for its implementation—the team members. The project manager becomes a collector, filterer, and organizer of each team member's perspective on how long he or she thinks various tasks will take. The project manager may move tasks assignments around in order to make things fit. Since consistent iteration duration provides a rhythm around which team members coalesce, the project manager may even decide to postpone certain functionality in order to preserve the fidelity of overall iteration timing.

Tracking Risk

The risk list is another key artifact managed by the project manager. A risk list is a prioritorized list of risks maintained for the purpose of driving planning activities. The risk list is created in Inception and is consulted prior to and revised after each iteration. Particularly prior to Construction, this revision is key. Most of elaboration centers on reduction of risk. A risk list that is non-existent, or is not being actively managed, is an indication that a project is drifting away from proper risk management, and should not be considered as conforming to the principles of the present invention.

In the Architectural Workflow, technical risks were discussed. Not all risks are technical. Many risks are often political, and/or outside of a project's immediate control. Examples include: Resource shortages, Executive inattention, Lack of departmental or partner cooperation, and Changing market conditions.

Experience and control are two key guidelines for identifying many kinds of risks. Any primary element of the project with which team members have either no direct experience or cannot call on the experience of a trusted source, is a risk. This includes: External partners or suppliers. Even their guarantees may cover only the relatively minor issue of their cost, whereas their failure may mean the failure of the project overall.

Unless the team has specific experience with a particular piece of software, it should be considered a risk. Even new versions of well-understood software constitute some degree of risk. The risk becomes more severe if the originators of the proffered components are unable to verify its qualities themselves. External systems which are unlikely to have been written with the particular perspectives of your application area in mind. The degree to which either they insist on maintaining complete control, or to which they provide an execution or domain model with little flexibility, may require considerable effort to accommodate.

Having seen solutions to similar problems which involve apparent difficulty and perhaps conflict. For example, certain systemic qualities may conflict with one another, such as incorporating multiple machines vs. the need for simplified management, or the goal of ease of use with the goal of tight security. Meeting throughput goals is probably the most common risk area, which is made worse by the uncertainty introduced by aggregating software components from multiple sources.

Base technologies such as a programming language or new platform although common industry experience may be heavily relied on. Tools on which important outcomes reside. Team dynamics such as individuals or groups that have not worked together before. Physical remoteness or other factors limiting communication should also be considered. The target domain, which if complex and/or not well documented may involve learning and ramp-up time for some or all members of the team. The methodology, even if understood academically, may result in additional overhead for learning how to apply it in real-world circumstances.

Control without responsibility should be avoided at all costs, but if it exists must be characterized as a risk. Examples include: Having to meet a date which someone else defined, Having to provide functionality which you know is not well defined, Having to rely on a technology which you have not validated. The risk list should still include any of those risks, if in fact the project will ultimately be held accountable. In other words, the risk list represents areas that must be actively managed by the project itself.

Estimation

Estimation can be driven based on use cases. The present invention recommends a baseline approach that can be subsumed by more detailed and thorough approaches as required. The process is roughly as follows: Begin by having the key business stakeholders rate each use case as high, medium, or low in importance relative to the business objectives; Refer back to the Vision statement to help keep focus on priorities; the high-priority set of use cases and the key business drivers in the Vision document should be consistent with one another; Define three levels of effort estimation corresponding to high, medium, or low. For example (and just as an example), low might be one week, medium two weeks, and high three weeks. These numbers are defined by the key project technical personnel as well as the project manager, and based on the team's experience. If new to use cases, draw from other experience. As the project progresses, and particularly in earlier iterations, the duration estimates should be revised at the end of each iteration (more on this later).

Next, rate each use case by estimated effort in terms of high, medium, or low, and also rate the confidence in that attribute as high, medium, or low. For example, we might say that use case 17 appears to be a hard use case (high effort), but our confidence is low in that estimation (low confidence) so it may prove to be much easier. Outlying use cases that do not fit well in the three effort categories can be merged or split at this time.

Next, identify risk areas by asking why each low-in-confidence use case is rated as such. Do the same for medium-in-confidence use cases. Based on the identified risk areas, determine the smallest set of use cases which if built will result (based on current knowledge) in all use case confidence ratings to be driven to high. These will be the architecturally significant use cases. Prioritorize these based on the priority of the risks they represent. Define the scope of the elaboration phase in terms of use cases. These can be just the set of architecturally significant use cases from step 5, or it can be extended based on other usually non-technical risk factors.

For example, you might be building an order entry system and not have included the common case of Enter Order as an architecturally significant use case. If the team has determined that there is a political risk that can be mitigated by demonstrating recognizable progress for this common use case, then include it in the elaboration scope. Or, the development environment itself might have been identified as a risk due to several novel factors being employed, so an easier use case might be selected to work on while solidifying the environment. Be cautious about this, as adding functionality focused work quickly dilutes the intent of elaboration.

Estimates for elaboration and construction can be determined from their respective use cases and duration estimates. Be sure to anticipate additional factors, such as time for: Coordination overhead in elaboration, as the team may be working together for the first time, may be new to the process, or may have to solidify the development environment, etc.; Rework, as some amount of code will have to be repaired or refactored as the project proceeds; Elaboration rework will depend on your perception of the amount of risk involved overall; the more risk, the more likely things will go wrong and mitigation plans put into effect; Potential change requests depending on your perception of the volatility of end-user requirements; Some of the factors identified in step 7 can also be accounted for in Transition, during beta test. Low priority features may also be assigned to the Transition phase, which should also account for such factors as documentation, acceptance-testing, complexity of the rollout process, etc. If in inception, a detailed iteration plan for the first elaboration phase should be constructed, further validating the overall estimates.

If delivery time is critical, it may be worthwhile to consider an alternate plan in which only high or medium arid high priority use cases are addressed in elaboration, which may shorten its duration. High-risk lower priority use cases can still be addressed in construction, adapting the mitigation plan that if they don't work then they will simply be dropped for this release. The end of each iteration presents an opportunity to refine estimates. Experience is the best guide: if an iteration takes 2 times longer than expected, then you might consider extending the remainder of your estimates within the same phase by 2. You might also consider extending the estimates for the subsequent phase by the same or a similar amount, but the variables between phases may make this difficult to estimate.

Thus, a method and apparatus for computer system engineering is described in conjunction with one or more specific embodiments. The invention is defined by the claims and their full scope of equivalents.

1. A method for engineering a computer system comprising:
implementing a requirements workflow;
implementing an architectural workflow;
implementing a realization workflow;
implementing a validation workflow; and
implementing a project management workflow;

2. The method of claim 1 wherein said requirements workflow, said architectural workflow, said realization workflow, said validation workflow, and said project management workflow all undergo one or more phases.

3. The method of claim 2 wherein said phases comprise an inception phase.

4. The method of claim 3 wherein said phases comprise an elaboration phase.

5. The method of claim 1 wherein said phases comprise a construction phase.

6. The method of claim 1 wherein said phases comprise a transition phase.

7. The method of claim 2 wherein said phases undergo one or more iterations.

8. The method of claim 2 wherein said requirements workflow includes a functional requirements component and a systemic requirements component.

9. The method of claim 2 wherein said requirements workflow includes a product vision document, a glossary, a requirements document, and a project plan.

10. The method of claim 1 wherein said implementing an architectural workflow comprises:
obtaining a proposed system architecture;
decomposing said proposed system architecture into one or more smaller units;
assigning each of said smaller units a responsibility and a context;
determining if each of said smaller units may be purchased or developed in isolation; and
performing a recursive process, if so.

11. The method of claim 1 wherein said implementing an architectural workflow comprises:
making a software architecture document.

12. The method of claim 11 wherein said software architecture document includes one or more containers and one or more components inside said containers.

13. The method of claim 12 wherein said components include an executable code, a source file, a Java Virtual Machine, and a file.

14. The method of claim 12 wherein said containers include an application runtime, a file system, a host operating system, and a compilation system.

15. The method of claim 11 wherein said software architecture document includes an application layer, an upper platform layer, and a lower platform layer.

16. A system for engineering a computer system comprising:
a requirements workflow configured to be implemented;
an architectural workflow configured to be implemented;
a realization workflow configured to be implemented;
a validation workflow configured to be implemented; and
a project management workflow configured to be implemented;

17. The system of claim 16 wherein said requirements workflow, said architectural workflow, said realization workflow, said validation workflow, and said project management workflow all undergo one or more phases.

18. The system of claim 17 wherein said phases comprise an inception phase.

19. The system of claim 18 wherein said phases comprise an elaboration phase.

20. The system of claim 16 wherein said phases comprise a construction phase.

21. The system of claim 16 wherein said phases comprise a transition phase.

22. The system of claim 16 wherein said phases undergo one or more iterations.

23. The system of claim 17 wherein said requirements workflow includes a functional requirements component and a systemic requirements component.

24. The system of claim 17 wherein said requirements workflow includes a product vision document, a glossary, a requirements document, and a project plan.

25. The system of claim 16 wherein said architectural workflow comprises:
a proposed system architecture configured to be obtained;
one or more smaller units configured to be decomposed from said proposed system architecture;
a responsibility and a context configured to be assigned to each of said smaller units;
a recursive process configured to be performed if it is determined that each of said smaller units may not be purchased or developed in isolation.

26. The system of claim 16 wherein said architectural workflow comprises:
a software architecture document configured to be made.

27. The system of claim 26 wherein said software architecture document includes one or more containers and one or more components inside said containers.

28. The system of claim 27 wherein said components include an executable code, a source file, a Java Virtual Machine, and a file.

29. The system of claim 27 wherein said containers include an application runtime, a file system, a host operating system, and a compilation system.

30. The system of claim 26 wherein said software architecture document includes an application layer, an upper platform layer, and a lower platform layer.
